(19) United States
(12) Patent Application Publication
(10) Pub. No.: US 2024/0314477 A1
(43) Pub. Date: Sep. 19, 2024

(54) PLAYBACK DEVICES HAVING ADJUSTABLE TRANSDUCER POSITIONS

(71) Applicant: Sonos, Inc., Santa Barbara, CA (US)

(72) Inventors: Job Koreman, Delft (NL); Jens de Groot, Haarlem (NL); Bastiaan van Biezen, Amsterdam (NL)

(21) Appl. No.: 18/601,647

(22) Filed: Mar. 11, 2024

Related U.S. Application Data
(60) Provisional application No. 63/490,986, filed on Mar. 17, 2023.

(51) Int. Cl. H04R 1/02

(52) U.S. Cl. CPC H04R 1/025; H04R 2201/025

(57) ABSTRACT

There is provided a playback device, comprising: a first body portion, a second body portion, a first speaker driver mounted in the first body portion, a second speaker driver mounted in the second body portion and a substantially rigid connecting portion extending between the first body portion and the second body portion. The connecting portion is moveable and/or extendable to configure the playback device in at least a first configuration and a second configuration. In the second configuration the first and second body portions are arranged farther apart than in the first configuration.

### CROSS-REFERENCE TO RELATED APPLICATIONS

The present application claims the benefit of priority to U.S. Patent Application No. 63/490,986, filed Mar. 17, 2023, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a functional block diagram illustrating certain aspects of an example playback device;

FIG. 1B is a front perspective view of a playback device that includes a user interface, according to an example;

FIG. 2A is a front perspective view of another example playback device;

FIG. 2B is a front perspective view of the playback device of FIG. 2A without a grille;

FIG. 3A is a perspective view of another example playback device, the playback device comprising two body portions, and arranged in a first configuration;

FIG. 3B is top-down view of the playback device of FIG. 3A;

FIG. 3C is side view of the playback device of FIG. 3A;

FIG. 3D corresponds to the view of FIG. 3C, with partial transparency;

FIG. 3E is a side view of a modified version of the playback device of FIGS. 3A-3D, with partial transparency;

FIG. 4A is a side view of the playback device of FIGS. 3A-3D arranged in a second configuration;

FIG. 4B corresponds to the view of FIG. 4A, with partial transparency;

FIG. 4C is a perspective view of the playback device of FIGS. 4A and 4B;

FIG. 5A is a side view of an example playback device arranged in a first configuration, with partial transparency;

FIG. 5B is a side view of the playback device of FIG. 5A, arranged in a second configuration, with partial transparency;

FIG. 6A is a side view of an example playback device arranged in a second configuration, the playback device having an extendable connecting portion;

FIG. 6B corresponds to the view of FIG. 6A, with partial transparency;

FIG. 6C is a perspective view of the playback device of FIGS. 6A and 6B;

FIG. 7A is a side view of an example playback device arranged in a second configuration, the playback device capable of being configured in at least three different configurations;

FIG. 7B is a side view of the playback device of FIG. 7A, where playback device is arranged between the second configuration and a third configuration;

FIG. 7C is a side view of the playback device of FIG. 7A, where playback device is arranged in the third configuration;

FIG. 7D is a side view of the playback device of FIG. 7A, where playback device is arranged in a first configuration;

FIG. 8A is a schematic diagram of a playback environment comprising a listener and an example playback device, the playback device being arranged in a particular configuration;

FIG. 8B corresponds to the environment of FIG. 8A, the playback device being arranged in a different configuration from FIG. 8A;

FIG. 9A is a schematic top-down view of a playback environment comprising a listener and an example playback device, the playback device facing a particular direction;

FIG. 9B corresponds to the environment of FIG. 9A, the playback device being facing a different direction from FIG. 9A;

FIG. 10 is a schematic diagram of a playback environment comprising two example playback devices, the playback devices being arranged in different configurations, such that their second body portions are arranged at different heights;

FIG. 11 is a schematic diagram of a playback environment comprising two example playback devices, the playback devices being arranged in different configurations, such that their second body portions are arranged at the same height;

FIG. 12 is a side view of another example playback device, the playback device having a side portion;

FIG. 13 is a side view of another example playback device, the playback device having two side portions; and

FIG. 14 is a side view of another example playback device, the playback device having two connecting portions extending between two body portions.

### DETAILED DESCRIPTION

### I. Overview

Embodiments described herein relate to playback devices, including, for instance, a playback device having at least two body portions, where at least one body portion is moveable with respect to the other body portion(s) to increase a spacing/distance between the body portions. In some embodiments, only one body portion is moveable with respect to the other. Each body portion contains at least one speaker driver (such as a transducer) for outputting sound/audio, so the spacing between speaker drivers can be adjusted. The playback device can therefore be configured/transformed into two or more configurations. The different configurations can allow the playback device to output sound in different ways, which may be suited to particular situations for example.

As such, according to a first aspect of the invention, there is provided a playback device, comprising: (i) a first body portion, (ii) a second body portion, (iii) at least a first speaker driver mounted in the first body portion, (iv) at least a second speaker driver mounted in the second body portion, and (v) a substantially rigid connecting portion extending between the first body portion and the second body portion. The connecting portion is moveable and/or extendable to configure the playback device in at least a first configuration and a second configuration. In the second configuration the first and second body portions are arranged farther apart than in the first configuration.

Such a playback device can therefore be adjusted between two or more configurations, where the first and second speaker drivers are farther apart in the second configuration than they are in the first configuration. Separation of two speaker drivers in this manner allows the playback device to optimize its sound output. For example, the first and second drivers may output different audio channels (such as left and right channels) and separation of the two speaker drivers while in the second configuration allows the output of those channels to be spatially separated. Additionally or alternatively the first and second drivers may output different frequencies and separation of the two speaker drivers while in the second configuration allows the drivers to be positioned more appropriately for those frequencies. As an example, greater, more directional, frequencies may be output by the second speaker driver, and the second speaker driver can be arranged higher than the first speaker driver so that the higher frequency audio/sound can be output closer to the height of a listener's ears.

Movement and/or extension of the connecting portion can allow the playback device to be arranged in the two or more different configurations. In an example, in at least the second configuration, the second body portion is supported by the connecting portion. In some examples, in both the first and second configurations, the connecting portion extends between the first body portion and the second body portion.

In one example, the connecting portion is known as a supporting portion. In another example, the playback device comprises a connection system. The connection system may comprise a connecting portion and a drive system (such as one or more motors) to move and/or extend the connecting portion.

In certain examples, the substantially rigid connecting portion comprises at least one of: plastic, metal, a metal alloy and a composite material (e.g., a carbon fiber).

The rigidity of the connecting portion can allow the connecting portion to support the weight of the second body portion. For example, the connecting portion can hold the second body portion above the first body portion, or to one side of the body portion, without any other support. In a particular example, the connecting portion is arranged to retain/hold the first and second body portions in at least the second configuration. In some examples, the connecting portion is also arranged to retain/hold the first and second body portions in the first configuration.

In one example, the first configuration is a collapsed/lowered configuration (where the distance between the first and second body portions is a minimum). For example, the first and second body portions may be adjacent and/or abutting each other. Similarly, the second configuration may be an extended, expanded, and/or elevated configuration, such as a fully expanded or elevated configuration (where the distance between the first and second body portions is a maximum).

In particular examples, the connecting portion is adjustable in length, such as between at least a first length and a second length, the second length being longer than the first length, the lengths being measured between a first end of the connecting portion and a second end of the connecting portion.

In an example, the playback device comprises a further speaker driver mounted in the second body portion and/or a further speaker driver mounted in the first body portion.

In a particular example, in the second configuration, the connecting portion extends along a predetermined path, and the second body portion is moveable along the path as it moves between the first and second configurations.

The connecting portion may be straight or curved. For instance, U.S. patent application Ser. No. 17/648,282 filed on Jan. 18, 2022, and titled “Acoustic Port for a Playback Device,” which is hereby incorporated by reference in its entirety, describes curved ports.

In particular examples, the playback device is further configurable in a third configuration, in which the first and second body portions are arranged farther apart than in the first configuration, and closer together than in the second configuration.

In some examples, the playback device is configured to adjust the playback device between at least the first and second configurations, such as via a motor or actuator. Alternatively, or additionally, the connecting portion is configured to be moveable and/or extendable manually (such as by a listener/user).

In examples, the connecting portion is tubular. The connecting portion may have a circular cross-section, or another cross section such as oval, elliptical, rectangular and so on. The connecting portion may have a hollow interior. A cross-section of the connecting portion and/or the hollow interior may vary along its length. For example, an end portion of the connecting portion may be flared outwardly.

In some examples, the connecting portion is defined by having particular dimensions, including one or more of: a length, an effective length, a cross-sectional width (such as a diameter), and/or a cross-sectional area. The connecting portion length may be defined between two ends of the connecting portion. The “effective length” of the connecting portion may be defined between a first end of the connecting portion and an open aperture along the length of the connecting portion, rather than between two ends of the connecting portion. The aperture may have a diameter or define an area.

In examples, the first body portion has a first internal volume, and the second body portion has a second internal volume. In a particular example, the second internal volume is less than the first internal volume.

As mentioned, in one example, the first body portion is a lower portion of the playback device and the second body portion is an upper body portion of the playback device, and the connecting portion is moveable or extendable to adjust the height of the upper body portion relative to the lower body portion. Adjusting the height of the upper body portion allows a greater height separation of the first and second speaker drivers.

It will be appreciated that reference to a height adjustment of the second body portion is relative to the orientation of the playback device. For example, in storage or transit, the playback device may be stored on its side. As such, the height adjustment relates to the orientation of the playback device during use (such as when a listener is listening to audio output by the playback device).

In an example, the height of the upper body portion relative to the lower body portion is based on one or more of: a location of the playback device; a characteristic of the audio being, or to be, played back by the playback device; an audio output parameter of the playback device; an operation mode of the playback device; and a command, the command being based on user input to the playback device or user input to a user device in communication with the playback device.

The location may be inside or outside and/or may be determined from a zone which the playback device is part of. For example, a zone named “garden” may be used to determine an outside location, and a zone named “living room” may be used to determine an inside location. Alternatively, or additionally, a zone may be associated with metadata of its location. The location may be a location of the playback device within the playback environment (e.g., a room), such as the height difference between the playback device and a floor or ceiling, or the height difference between the playback device, or a part of the playback device, and a listener's head/ears. The location may be relative to a listener and/or one or more other playback devices. U.S. Pat. No. 9,084,058 filed on Dec. 29, 2011, and titled “Sound Field Calibration Using Listener Localization,” which is hereby incorporated by reference in its entirety, provides in more detail some examples for playback devices determining the location(s) of one or more listeners.

The characteristic of the audio may be a type of audio (such as a genre), or an audio channel (such as left, right, center, etc.), a number of audio channels (such as stereo, 5.1, 7.1, spatial audio, etc.) or a frequency range (or center frequency) of the audio, etc. For example, the playback device may be arranged in the second configuration for audio having a higher frequency output.

An audio output parameter might be a volume setting of the playback device, and/or an equalization setting, for example.

The operation mode may be based on the particular audio channels(s) and/or number of audio channels assigned to the playback device for playback. In another example, the operation mode may be “party mode” for example, and may be set based on a command and/or time of day, and/or other trigger. In another example, the operation mode may be indicative of the listener/user controlling/listening to the playback device. For example, a first user may be taller than a second user, so the height adjusts based on the height of the listener/user. A user may prefer the playback device to operate in a particular configuration when listening to the playback device, so the playback device automatically adjusts its configuration based on who is listening/operating the playback device. The user/listener may be inferred by the user device communicating with the playback device, for example. Similarly, a first user may tend listen to the playback device while sitting down, or laying on a bed, so the playback device remains in the first configuration. A second user may tend to listen to the playback device while standing up, so the playback device adjusts to be in the second configuration.

In some examples, the second speaker driver mounted in the upper body portion is configured to output higher frequency audio/sound than the first speaker driver mounted in the lower body portion. Adjusting the height of a driver that outputs frequencies higher than a lower frequency driver allows the driver to be positioned at or closer to car level, which can greatly improve the listening experience because higher frequencies tend to be more directional than lower frequencies. This may also be useful, for example, in situations where the playback device addresses a large crowd for at least the reason that elevating the higher frequency driver(s) can mitigate attenuation of mid and high-range frequencies that can occur in crowded environments.

The upper body portion may comprise one or more speaker drivers, such as one or more high frequency drivers and/or one or more mid-range drivers. The lower body portion may comprise one or more speaker drivers, such as one or more low frequency drivers and/or one or more mid-range drivers. For example, in one scenario, the upper body portion comprises a high frequency driver (such as a tweeter), and the lower body portion comprises a full-range driver, a mid-range driver or a low frequency driver (such as a woofer). In another scenario, the upper body portion comprises a full-range or a mid-range driver and the lower body portion comprises a low frequency driver.

In some examples, the playback device further comprises a third speaker driver mounted in the upper body portion, wherein the third speaker driver is configured to output higher frequency audio/sound than the first speaker driver mounted in the lower body portion. For example, in one scenario, the upper body portion comprises two or more high frequency drivers and the lower body portion comprises one or more mid-range drivers and/or one or more low frequency drivers. In another scenario, the upper body portion comprises two or more full-range or mid-range drivers and the lower body portion comprises at least one low frequency driver. In another scenario, the upper body portion comprises one or more mid-range drivers and one or more high frequency drivers, and the lower body portion comprises one or more low frequency drivers and/or one or more mid-range drivers.

Having multiple drivers that output frequencies higher than a lower frequency driver improves the coverage of the higher frequency audio output, which tends to be directional than lower frequencies. For example, the third speaker driver can have a sound axis (defined by the direction in which audio with the highest sound pressure level (SPL) is output) that is oriented in a different direction to the sound axis of the second speaker driver. The respective sound axes may be in a same plane in some examples.

In some examples, one or more drivers can be activated when the playback device is adjusted to the second configuration. Sound distribution and/or the volume of the audio can be increased by activating at least one further speaker driver when the playback device is in the second configuration. In some cases, access to the third speaker driver may be limited while in the first configuration (for example, it may be hidden or obstructed), which can allow the playback device to have a smaller form factor. Accordingly, in an example, in the first configuration: (i) the second speaker driver is in an active state, such that the second speaker driver outputs audio, and (ii) the third speaker driver is in a deactivated state, such that the third speaker driver does not output audio. In the second configuration: (i) the second speaker driver is in an active state, such that the second speaker driver outputs audio, and (ii) the third speaker driver is in an active state, such that the third speaker driver outputs audio. In the first and second configurations, the first speaker driver is in an active state, such that the first speaker driver outputs audio.

In a particular example, the playback device is configured to change the third speaker driver from the deactivated state to the active state based on the playback device being adjusted from the first configuration to the second configuration.

In alternative examples, rather than having the second body portion positioned above the first body portion, the two body portions may be separable in horizontal distance (although it will be appreciated that in some cases, there may additionally be an adjustment in height between the two body portions). As such, in certain examples, the second body portion is a side portion of the playback device, and the connecting portion is moveable or extendable to adjust the horizontal separation between the first body portion and the side portion of the playback device. Adjusting the horizontal spacing between the first and second speaker drivers can provide a greater stereo separation (when the first and second drivers output different channels of audio) and/or increase the “wideness”, such as the soundstage, of the audio output by the playback device. When transducers are too close, the sound can interfere; for example, a left and right channel can interfere, which provides a negative listening experience. A greater stereo separation may allow a listener to experience the stereo sound from a greater number of locations. For example, when the transducers are closer together, the optimal listening area is smaller than when the transducers are farther apart.

It will be appreciated that reference to a horizontal spacing of the second body portion is relative to the orientation of the playback device. For example, in storage or transit, the playback device may be stored on its side. As such, the horizontal spacing adjustment relates to the orientation of the playback device during use (such as when a listener is listening to audio output by the playback device). In some examples, a playback device may be oriented in either of a horizontal orientation or a vertical orientation in use. In certain examples, the playback device may be oriented in a different orientation other than strictly horizontal or vertical. In such examples the first and second configuration may adjust, for instance, a relative height or a horizontal spacing depending on the orientation in use.

In an example, the first speaker driver mounted in the first body portion is configured to output a left audio channel or a right audio channel, and the second speaker driver can be configured to output the other of the left audio channel and the right audio channel.

The first body portion may be referred to as a second side portion of the playback device, in some examples.

In certain examples, the playback device further comprises a third speaker driver mounted in the side portion. In some examples, in the first configuration: (i) the second speaker driver is in an active state, such that the second speaker driver outputs audio, and (ii) the third speaker driver is in a deactivated state, such that the third speaker driver does not output audio, and in the second configuration: (iii) the second speaker driver is in an active state, such that the second speaker driver outputs audio, and (iv) the third speaker driver is in an active state, such that the third speaker driver outputs audio.

In an example, the playback device may comprise three body portions-two side portions arranged on either side of the first body portion, which are moveable in at least a first direction (i.e., horizontally) away from and/or toward the first body portion. Accordingly, in an example, the playback device comprises: (i) a third body portion, (ii) a third (or further) speaker driver mounted in the third body portion, and (iii) a second substantially rigid connecting portion extending between the first body portion and the third body portion, wherein the second connecting portion is moveable or extendable to configure the playback device in at least the first configuration and a third configuration, wherein in the third configuration the first and third body portions are arranged farther apart than in the first configuration, and wherein the third body portion is a second side portion of the playback device, wherein the first body portion is arranged between the second side portion and the side portion in at least the first configuration.

In some cases, the connecting portion has a length based on at least one of: a tuning frequency of the playback device (such as between about 20-300 Hz, such as a bass frequency or low frequency), a diameter of the connecting portion, and/or an internal volume of the first body portion (such as the lower body portion). The length may be the overall length of the connecting portion, or an effective length (where the “effective length” of the connecting portion is measured between a first end of the connecting portion and an open aperture along the length of the connecting portion).

The substantially rigid connecting portion may at least partially define a bass port of the playback device. Alternatively, the connecting portion may be an extendable/telescopic or moveable rod.

A bass port may be alternatively known as a “bass reflex”, “reflex port”, amongst others. Using a bass port of the playback device as a connecting portion allows the connecting portion to serve a dual purpose, potentially reducing the requirement for the playback device to include additional components and/or making more efficient use of the internal volume. This is particularly useful for playback devices that are portable.

For example, for a bass port is a tube of circular cross-section having a length and cross-sectional width (such as a diameter). The dimensions of the bass port are typically selected to enhance low frequency audio output of the playback device. The dimensions are therefore selected/tuned to match a particular low frequency (known as a tuning frequency), f, of audio that is to be enhanced. As such, when designing a playback device, the length of the bass port, L in cm, the diameter of the bass port, D in cm, the number of bass ports, N, the internal volume of the playback device (i.e., the internal volume of the portion of the playback device housing a low frequency driver, in this case the first body portion), V in liters, and the end correction factor, k, are adjusted to match the frequency, f in Hz. These parameters are related according to the following equation:

$$L = \frac{2.35625 \times 1 {0}^{4} \times {D}^{2} \times N}{V \times {f}^{2}} - k \times D$$

The end correction factor, k is based on the shape of the bass port. For example, if both ends of the bass port are flanged: k=0.850, if one end is flanged and one end is free: k=0.732 and if both ends are free: k=0.614. As an example, L=10.7 cm when D=3 cm, N=1, V=11.4 L, f=38 Hz and k=0.732. It will be appreciated that other profiles of bass ports will not be governed by exactly the same equation, and the skilled person understands how to specify or design a bass port which is not a tube of circular cross section. Similarly, numerical as well as analytical design techniques can be used.

In some examples, the bass port has a length that is less than a length of the connecting portion. For example, the connecting portion may have an opening/aperture along its length (i.e., between ends of the connecting portion) which defines an end of the bass port. As such, the bass port may extend the full length of the connecting portion or may extend part of the length of the connecting portion. In cases where the bass port extends part of the length of the connecting portion, the bass port length may be equal to an effective length of the connecting portion, where the connecting portion has a length greater than the effective length.

In some examples, in at least the first configuration, the bass port extends at least partially inside the first body portion and at least partially inside the second body portion. In a particular example, the bass port extends at least partially inside the first body portion and passes completely through the second body portion. The second body portion may define a volume which is separate from the volume of the first portion.

The bass port may be moveable within the first body portion as the playback device moves between the first and second configurations. The bass port may have a fixed position within the second body portion as the playback device moves between the first and second configurations. The bass port may be straight or curved.

The playback device may be a portable playback device and comprise a battery for powering the portable playback device. In some examples, the playback device is configured for outdoor use (for example, the first and second body portions may be moisture and/or water-resistant).

In some examples, the connecting portion is adjustable in length, between at least a first length and a second length, the second length being longer than the first length, the length being measured between a first end of the connecting portion and a second end of the connecting portion, and the connecting portion delimits an aperture positioned at a point on the length of the connecting portion between the first end and the second end. When the connecting portion has the first length: (i) the aperture is closed, and (ii) the bass port has a length substantially equal to the first length, and when the connecting portion has the second length: (iii) the aperture is open, and (iv) the bass port has a length substantially equal to the first length, the length of the bass port being measured between the first end of the connecting portion and the open aperture.

The connecting portion may therefore be telescopic to allow the separation between the first and second body portions to be set to be at least two distances. In some cases, varying the length of the bass port can have an undesirable effect on the sound output of the playback device. Having an aperture along the side of the connecting portion allows the bass port to have a length that is the same at each of the two distances, minimizing the impact on the sound output. As such, an “effective length” of the connecting portion may define the length of the bass port (the effective length being measured between the first end of the connecting portion and the open aperture). The bass port therefore terminates at the aperture (when it is open) and the first end of the connecting portion. When the aperture is closed, the bass port extends between the first and second ends of the connecting portion. In one case, the aperture is on a side of the connecting portion. More than one aperture may be provided, for example two or more apertures spaced around a circumference, or perimeter of a cross section through the connecting portion.

In some cases, the connecting portion has the first length when arranged in the first configuration and the connecting portion has the second length in the second configuration. The playback device may also have the first length while arranged in a third configuration (in which the first and second body portions are arranged farther apart than in the first configuration, and closer together than in the second configuration).

The first end of the connecting portion may be inside the first body portion. The second end of the connecting portion may be at a surface of the second body portion (such as an outer surface).

In some examples, when the connecting portion has lengths between the first and second lengths, the aperture remains closed (or is only partially open), or no aperture is provided. As such, the bass port may also have a variable length. The playback device may be configured to adjust at least one audio output parameter (such as a volume setting and/or an equalization setting) based on the length of the bass port to compensate for the variable length of the bass port and any effect it may have on the sound output by the playback device. In some examples, the playback device may also be configured to adjust at least one audio output parameter based on whether the connecting portion has the first length or the second length. Examples of adjusting audio parameters are described in U.S. Pat. No. 9,084,058, which is already incorporated by reference above.

In certain examples, in the first configuration, the connecting portion extends into the first body portion by a first distance, in the second configuration, the connecting portion extends into the first body portion by a second distance, the second distance being less than the first distance, and the playback device is configured to adjust at least one audio output parameter of the playback device based on whether the playback device is arranged in the first configuration or the second configuration. As such, the bass port can be moved/displaced relative to the first body portion. Adjusting the bass port displacement can alter how audio is perceived/heard by a listener for at least the reason that it can change the overall volume which the bass port interacts with. To compensate for the change, the playback device can adapt how audio is output so that the audio is not perceived to have changed (or any perception of change is reduced). Adjusting an audio parameter of the playback device therefore causes the playback device to modify the audio output by the playback device, however, to a listener, the perceived sound output may be the same.

An audio output parameter might be a volume level setting of the playback device, and/or an equalization setting for example.

In some cases, the connecting portion is adjustable in length, between at least a first length and a second length, the second length being longer than the first length, the length being measured between a first end of the connecting portion and a second end of the connecting portion and the playback device is configured to adjust at least one audio output parameter based on whether the connecting portion has the first length or the second length. As such, in examples where the connecting portion does not have an aperture to compensate for the variable length of the connecting portion, the playback device may adapt how audio is output based on the length of the connecting portion, since the length of the connecting portion can alter how audio is perceived by a listener. In examples, the connecting portion has the first length in the first configuration and the second length in the second configuration. The bass port may therefore be defined by the length of the connecting portion, and the bass port is therefore adjustable in length.

The connecting portion may have the first length in a third configuration, or a third length in a third configuration, the third length being longer than the first length and shorter than the second length (the third configuration being a configuration in which the first and second body portions are arranged farther apart than in the first configuration, and closer together than in the second configuration).

In particular examples: (i) the connecting portion has a first end and a second end, (ii) in the first configuration at least one of the first and second ends are sealed, and (iii) in the second configuration the first and second ends of the connecting portion are open. For example, one end, such as a first end of the connecting portion, may be sealed by being flush with an inner surface of the first body portion, which may be useful to maximise the length of the connecting portion (thereby allowing a greater separation distance between the first and second portions). In another example, a second end of the connecting portion may alternatively or additionally be scaled by being flush with an outer surface of the first body portion (for example, the connecting portion may be bent or curved, such that the second end terminates in a gap or spacing between the first and second body portions when the playback device is in the first configuration). Sealing the second end of the connecting portion may be useful to stop dust and other debris or objects from entering the connecting portion. Sealing at least one end of the connecting portion may mean that the bass port does not function. This may be disadvantageous at high audio output volumes, but not having a functioning bass port may not be noticeable to a listener when the playback device is operated at relatively low audio output volumes, such as a volume below a threshold, or when the type of music being listened to has relatively less bass (low) frequency content. As such, the fact that the bass port does not function may not be problematic in certain circumstances, particularly when the advantages of having a connecting portion sealed at least one end are apparent. It may therefore be more beneficial to seal at least one end of the bass port when the playback device is in the first configuration.

As a first example, a listener may be listening to the playback device in the first configuration, where at least one of the first and second ends are sealed. This may not be problematic for the listener when listening to audio at a low volume and/or with high-fidelity. For example, other parts of the system may compensate for the loss of efficiency in the lower frequencies. Playing at a lower volume could allow the system to do this.

As a second example, a listener may be listening to the playback device at high volume in the first configuration, where at least one of the first and second ends are sealed, and the entire playback device is elevated to car level. As such full extension of the connecting portion would be undesirable. In this case, it may be desirable to only partially extend the connecting portion (rather than fully extend the connecting portion) to allow the connecting portion to be unsealed at both ends. Opening the connecting portion would allow a higher efficiency and thus improve output.

As a third example, a listener may be listening to the playback device at high volume in the second configuration. As mentioned, in this configuration the first and second ends of the connecting portion are open, thereby improving efficiency and improving output.

In an example, in the first configuration, the first end of the connecting portion is sealed by being flush with an inner surface of the first body portion. Additionally, or alternatively, in the first configuration, the second end of the connecting portion may be sealed by being flush with an outer surface of the first body portion, wherein the second end terminates at a surface of the second body portion that is arranged adjacent to (or flush with) the outer surface of the first body portion in the first configuration. In an example, the connecting portion is curved or bent such that the second end of the connecting portion may be sealed by being flush with an outer surface of the first body portion.

In some cases, the playback device is configured to adjust the playback device between the first and second configurations based on an audio output parameter of the playback device (such as a volume setting or an equalization setting), and/or a characteristic of the audio being, or to be, played back by the playback device. In other words, if the bass port is required (such as at higher volumes and/or higher bass output in the audio), the playback device may be moved to the second configuration so that the end(s) of the bass port are no longer sealed.

In some examples, the playback device may be configured to adjust at least one audio output parameter of the playback device based on whether the playback device is arranged in the first configuration or the second configuration. For example, the audio output volume may be set to be no higher than a particular level and/or a particular equalization setting may be adopted.

In some arrangements, the playback device comprises one or more wires configured to carry data and/or power between the first and second body portions, and these wires pass through or are routed along the connecting portion. As such, one or more wires configured to carry data and/or power extend between the first and second body portions via the connecting portion. This avoids having one or more wires being manually connected to the second speaker driver, and/or one or more wires being external to the playback device.

As such, the one or more wires may extend along (such as being adhered to) a surface of the connecting portion, or be integrated/embedded within a surface of the connecting portion, such as an inner or outer surface. The one or more wires may extend internally through the connecting portion (for example, the connecting portion may be tubular and have a hollow interior through which the one or more wires extend or are routed).

In some examples, the playback device further comprises a second substantially rigid connecting portion extending between the first body portion and the second body portion, wherein the second connecting portion is moveable or extendable to configure the playback device in at least the first configuration and the second configuration. Having two, or more, connecting portions can provide increased stability. As such, the connecting portion referred to earlier may be a first connecting portion. In some cases, the second connecting portion has a second length equal to a first length of the first connecting portion, but in other cases they may be different. In some cases, the second connecting portion has the same cross-sectional width (e.g., diameter, semimajor axis distance) as the first connecting portion, or may have a different cross-sectional width (e.g., diameter, semimajor axis distance) as the first connecting portion. The second substantially rigid connecting portion may also comprise (or be) a bass port. Alternatively, the second connecting portion may be an extendable/telescopic or moveable rod. The second connecting portion may have any of the features discussed above regarding the (first) connecting portion.

In particular examples, the playback device is configured to detect that the playback device is in at least one of: the first configuration and the second configuration. Detecting the configuration of the playback device allows the playback device to be aware of its configuration and can behave/operate accordingly. This may be useful in cases in which a user/listener manually/physically adjusts the playback device to move between configurations. The playback device may be further configured to take an action based on the detected configuration. The action taken by the playback device may comprise one or more of: adjusting at least one audio output parameter based on the configuration, activating or deactivating one or more speaker drivers based on the configuration, grouping the playback device with one or more other playback devices or leaving a group of one or more other playback devices, updating a user interface on a controller device communicatively coupled to the playback device, etc.

In examples, the playback device is further configured to detect that the playback device is in a third configuration.

In a particular example, the playback device may be configured to detect that the playback device is in the first configuration, and failure to detect that the playback device is in the first configuration may allow the first playback device to determine that it is in the second configuration.

In some arrangements, the second body portion is configured to rotate and/or tilt relative to the first body portion while the playback device is in at least the second configuration. In other words, the second body portion is configured to adjust its orientation relative to the first body portion while the playback device is at least in the second configuration.

The second body portion therefore has at least one additional degree of freedom of movement relative to the first body portion, where the first degree of freedom is translation of the second body portion relative the first body portion. This additional degree of freedom of movement can allow the second speaker driver (and any further speaker drivers mounted in the second body portion) to be arranged/pointed in a particular direction. For example, tilting the second body portion (and therefore the second speaker driver) in an upwards direction can allow the high (and/or mid-range) frequencies to be further directed towards a listener's ear height). Similarly, rotating the second portion can allow the high (and/or mid-range) frequencies to be directed towards a listener's location.

The rotation and/or tilting may be manually controlled by a user/listener. In other examples, the movement may be controlled by the playback device via, for instance, one or more actuators.

In a particular example, the playback device is configured to cause the second body portion to rotate and/or tilt relative to the first body portion based on a location of a listener. In other words, the playback device is configured to cause the second body portion to adjust its orientation relative to the first body portion based on a location of a listener.

The second body portion may therefore be automatically rotated and/or tilted such that high (or mid-range) frequency sound emitted from the second speaker driver is directed toward the listener location, thereby improving the listener sound experience.

The location of the listener may be determined based on a sensor of the playback device and/or another device. For example, an electromagnetic transmitter and/or detector of the playback device may sense the location of the listener, a camera system on the playback device may determine the location of the listener, and/or one or more microphones of the playback device may detect the location of a listener by having the listener and/or a user device, such as a controller, output a sound, which, when detected by the one or more microphones, can be processed to determine the location of the listener. In another example, the location of the listener may be inferred, and thereby determined, based on a location of a user device, such as a controller. The user device may transmit an electromagnetic signal and/or data and/or output sound which is detected by or received by the playback device, wherein the location of the listener can be determined based on the detected/received signal, data or sound.

Additionally, or alternatively, the playback device is configured to cause the second body portion to rotate and/or tilt relative to the first body portion based on at least one of: a type of audio content being output by the playback device, and a command, the command being based on user input to the playback device or a user device in communication with the playback device, such as a controller. The user input may be a voice command received or detected by the playback device or user device. For example, a user may speak “rotate” or “rotate by 90 degrees”, “tilt”, “tilt upwards/downwards”, etc.

Additionally, or alternatively, the playback device is configured to cause the second body portion to rotate and/or tilt relative to the first body portion based on a location of a second playback device relative to the playback device. In some examples, the one or more sensors of the playback device are configured to determine a location of the second playback device relative to the playback device (such as a distance to the second playback device). The second playback device may be similarly configured, so that together they optimize sound coverage by the playback devices.

In some examples, the playback device is configured to adjust the playback device between the first and second configurations based on one or more of: (i) a characteristic of the audio being, or to be, played back by the playback device, (ii) a location of the playback device, (iii) an audio output parameter of the playback device, (iv) an operation mode of the playback device, and (v) a command, the command being based on user input to the playback device or a user device in communication with the playback device.

The playback device can therefore itself adjust its configuration based on certain criteria, thereby automatically optimizing the sound output without requiring a user to physically adjust the configuration of the playback device.

In examples, the playback device comprises a drive mechanism (such as one or more motors) to cause the connecting portion to move and/or extend thereby adjusting the playback device between the first and second configurations.

As mentioned, the characteristic of the audio may be the type of audio (such as the genre), or the audio channel or number of audio channels or a pitch (or average pitch) of the audio, etc. For example, if the audio has one channel (i.e., mono), the playback device may remain in the first configuration (since stereo separation is not required).

As mentioned, the operation mode may be based on the particular audio channels(s) and/or number of audio channels assigned to the playback device for playback. For example, the playback device may be assigned to output one channel (such as a left or right channel), so the playback device may be in the first configuration (since stereo separation is not required) but if the playback device is assigned to output two channels (such as left and right channels), the playback device may be in the second configuration (to increase stereo separation, for example).

According to a second aspect of the invention, there is provided a system, comprising: (i) a first playback device, having: a first lower body portion, a first upper body portion, a first speaker driver mounted in the first lower body portion, a second speaker driver mounted in the first upper body portion, and a substantially rigid connecting portion extending between the first upper body portion and the first lower body portion. The connecting portion is moveable and/or extendable to configure the first playback device in at least a first configuration and a second configuration. In the second configuration the first upper body portion and the first lower body portion are arranged farther apart than in the first configuration. The system further comprises: (ii) a second playback device, having: a second lower body portion, a second upper body portion, a third speaker driver mounted in the second lower body portion, a fourth speaker driver mounted in the second upper body portion, and a second substantially rigid connecting portion extending between the second upper body portion and the second lower body portion. The second connecting portion is moveable and/or extendable to configure the second playback device in at least a first configuration and a second configuration. In the second configuration the second upper body portion and the second lower body portion are arranged farther apart than in the first configuration. The first and second playback devices form at least part of a group configured to output audio in synchrony. Based on a location of the first playback device within the playback environment, the first playback device is configured such that the first upper body portion of the first playback device is arranged at a first height within the playback environment and based on a location of the second playback device within the playback environment, the second playback device is configured such that the second upper body portion is arranged at a second height within the playback environment, the second height being different to the first height.

Accordingly, in some circumstances, the room geometry (i.e., the particular playback environment), for example, may mean that the overall sound output is optimized when the upper body portions are arranged at different heights, rather than both being at the same height (such as close to, or at, car height of a listener). This might be the case when one playback device is in a part of the room where the ceiling height is lower than in another part of the room where the other playback device is located.

The location of the playback device within playback environment may be determined using at least one of: (i) the playback device itself, and (ii) a controller.

The lower body portions of both playback devices may be arranged at approximately the same height within the playback environment when the playback devices are in the second configuration (and first configuration).

The first and second heights are relative to a common reference height, such as the floor.

In some cases, the first and second playback devices are identical or at least substantially the same.

The first playback device may be a playback device according to any of the playback devices described in the first aspect. Similarly, the second playback device may be a playback device according to any of the playback devices described in the first aspect.

The system may further comprise a controller configured to send an instruction to the first and/or second playback device to cause the first and/or second playback device to adjust between the first and second configurations.

According to a third aspect of the invention, there is provided a system, comprising: (i) a first playback device, having: a first lower body portion, a first upper body portion, a first speaker driver mounted in the first lower body portion, a second speaker driver mounted in the first upper body portion and a substantially rigid connecting portion extending between the first upper body portion and the first lower body portion. The connecting portion is moveable and/or extendable to configure the first playback device in at least a first configuration and a second configuration. In the second configuration the first upper body portion and the first lower body portion are arranged farther apart than in the first configuration. The system further comprises: (ii) a second playback device, having: a second lower body portion, a second upper body portion, a third speaker driver mounted in the second lower body portion, a fourth speaker driver mounted in the second upper body portion, and a second substantially rigid connecting portion extending between the second upper body portion and the second lower body portion. The second connecting portion is moveable and/or extendable to configure the second playback device in at least a first configuration and a second configuration. In the second configuration the second upper body portion and the second lower body portion are arranged farther apart than in the first configuration. The first and second playback devices form at least part of a group configured to output audio in synchrony. When the first and second playback devices are arranged at different heights within a playback environment: the first and second playback devices are configured such that the upper body portions of the first and second playback devices are at substantially the same height in the playback environment.

Accordingly, when the two playback devices are positioned at different heights within the environment, the sound output may be optimized/balanced when the second body portions are adjusted to be at the same height (or as close as possible) within the environment.

The lower body portions of both playback devices may be arranged at different heights within the playback environment when the playback devices are in the second configuration (and first configuration).

The heights are relative to a reference height, such as the floor.

In some cases, the first and second playback devices are identical (i.e., are the same make and model).

The first playback device may be a playback device according to any of the playback devices described in the first aspect. Similarly, the second playback device may be a playback device according to any of the playback devices described in the first aspect.

The system may further comprise a controller configured to send an instruction to the first and/or second playback device to cause the first and/or second playback device to adjust between the first and second configurations.

In some examples, the height of the upper body portions of the first and second playback devices is based on a location of a listener.

According to a fourth aspect of the invention, there is provided a playback device, comprising: (i) a first body portion, (ii) a second body portion, (iii) a first speaker driver mounted in the first body portion, (iv) a second speaker driver mounted in the second body portion, and (v) a connection system extending between the first body portion and the second body portion, wherein the connection system is operable to adjust the playback device between a first configuration and at least a second configuration, and in the second configuration the first and second body portions are arranged farther apart than in the first configuration. The playback device may comprise any or all of the features discussed above in respect of the first aspect of the invention.

According to a fifth aspect of the invention, there is provided a playback device, comprising: (i) a first body portion, (ii) a second body portion, (iii) a first speaker driver mounted in the first body portion, (iv) a second speaker driver mounted in the second body portion, and (v) a connecting portion extending between the first body portion and the second body portion, wherein the connecting portion is moveable or extendable along a predefined path, wherein the playback device is configurable in at least a first configuration and a second configuration, wherein in the second configuration, the second body portion is displaced from the first body portion in a direction along the path. The playback device may comprise any or all of the features discussed above in respect of the first aspect of the invention.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

In the Figures, identical reference numbers identify generally similar, and/or identical, elements. To facilitate the discussion of any particular element, the most significant digit or digits of a reference number refers to the Figure in which that element is first introduced. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Example Playback Device(s)

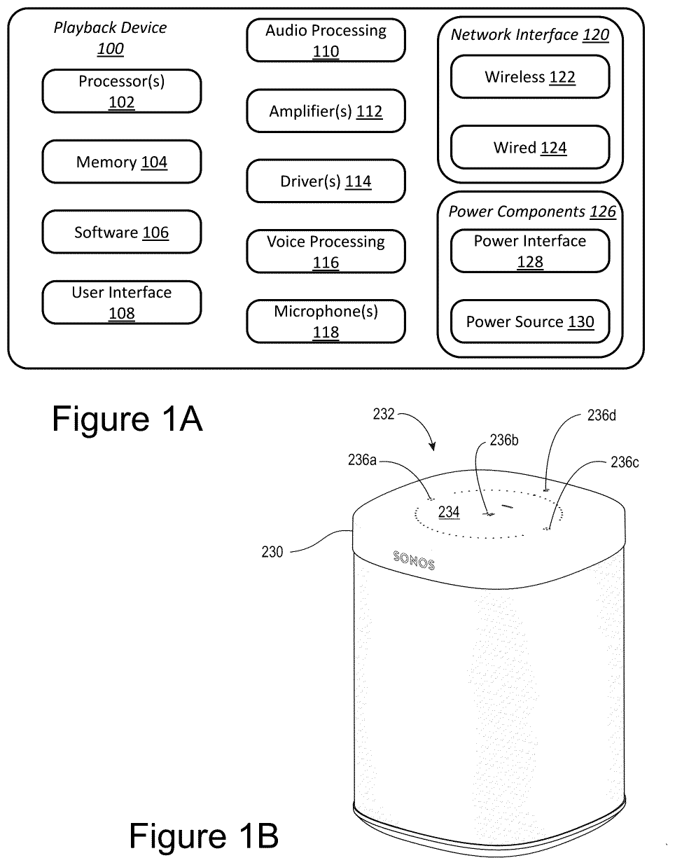

FIG. 1A is a functional block diagram illustrating certain aspects of an example playback device 100. The playback device 100 is configured to output audio via one or more drivers 114 into a playback environment in which the playback device is located (such as a room or outdoors). A driver may be known as a speaker driver and/or a transducer, in some cases. As shown, the playback device 100 includes various components, each of which is discussed in further detail below, and the various components of the playback device 100 may be operably coupled to one another via a system bus, communication network, or some other connection mechanism.

As shown, the playback device 100 includes at least one processor 102, which may be a clock-driven computing component configured to process input data according to instructions stored in memory 104. The memory 104 may be a tangible, non-transitory, computer-readable medium configured to store instructions that are executable by the one or more processors 102. For example, the memory 104 may be data storage that can be loaded with software code 106 that is executable by the one or more processors 102 to achieve certain functions.

In one example, these functions may involve the playback device 100 retrieving audio data from an audio source, which may be another playback device or another device, such as a user device or a remote server. In another example, the functions may involve the playback device 100 sending audio data, detected-sound data (e.g., corresponding to a voice input), and/or other information to another device on a network via at least one network interface 120. In yet another example, the functions may involve the playback device 100 causing one or more other playback devices to synchronously play back audio with the playback device 100. For example, the playback device 100 may be in a group with one or more other playback devices, where devices in the group play back audio in synchrony. In yet a further example, the functions may involve the playback device 100 facilitating being grouped (such as paired or otherwise bonded) with one or more other playback devices to create a multi-channel audio environment. Numerous other example functions are possible, some of which are discussed below.

As just mentioned, certain functions may involve the playback device 100 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 100 includes audio processing components 110 that are generally configured to process audio prior to the playback device 100 rendering the audio. In this respect, the audio processing components 110 may include one or more digital-to-analog converters (“DAC”), one or more audio preprocessing components, one or more audio enhancement components, one or more digital signal processors (“DSPs”), and so on. In some implementations, one or more of the audio processing components 110 may be a subcomponent of the processor 102. In operation, the audio processing components 110 receive analog and/or digital audio and process and/or otherwise intentionally alter the audio to produce audio signals for playback.

The produced audio signals may then be provided to one or more audio amplifiers 112 for amplification and playback through one or more drivers/transducers 114 operably coupled to the one or more amplifiers 112. The one or more audio amplifiers 112 may include components configured to amplify audio signals to a level for driving one or more of the drivers 114.

A driver 114 may be, for example, a subwoofer (e.g., for low frequencies), a mid-range driver (e.g., for middle frequencies), or a tweeter (e.g., for high frequencies). In some cases, a driver 114 may be driven by an individual corresponding audio amplifier of the one or more audio amplifiers 112.

In addition to producing audio signals for playback by the playback device 100, the audio processing components 110 may be configured to process audio to be sent to one or more other playback devices, via the network interface 120, for playback. In example scenarios, audio content to be processed and/or played back by the playback device 100 may be received from an external source, such as via an audio line-in interface (e.g., an auto-detecting 3.5 mm audio line-in connection) of the playback device 100 (not shown) or via the network interface 120, as described below.

As shown, the at least one network interface 120, may take the form of one or more wireless interfaces 122 and/or one or more wired interfaces 124. A wireless interface may provide network interface functions for the playback device 100 to wirelessly communicate with other devices (e.g., other playback device(s), and/or controller/user device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 100 to communicate over a wired connection with other devices in accordance with a communication protocol (e.g., IEEE 802.3). While the network interface 120 shown in FIG. 1A includes both wired and wireless interfaces, the playback device 100 may in some implementations include only wireless interface(s) or only wired interface(s).

In general, the network interface 120 facilitates data flow between the playback device 100 and one or more other devices on a data network. For instance, the playback device 100 may be configured to receive audio content over the data network from one or more other playback devices, network devices within a LAN, and/or audio content sources over a WAN, such as the Internet. In one example, the audio content and other signals transmitted and received by the playback device 100 may be transmitted in the form of digital packet data comprising an Internet Protocol (IP)-based source address and IP-based destination addresses. In such a case, the network interface 120 may be configured to parse the digital packet data such that the data destined for the playback device 100 is properly received and processed by the playback device 100.

As shown in FIG. 1A, the playback device 100 also includes voice processing components 116 that are operably coupled to one or more microphones 118. The microphones 118 are configured to detect sound (i.e., acoustic waves) in the environment of the playback device 100, which is then provided to the voice processing components 116. More specifically, each microphone 118 is configured to detect sound and convert the sound into a digital or analog signal representative of the detected sound, which can then cause the voice processing component 116 to perform various functions based on the detected sound. For example, the playback device 100 may obtain and then play back certain audio content based on a voice input from a user to play that audio content. In another example, the playback device may reconfigure itself based on a voice input from a user. In one implementation, the microphones 118 are arranged as an array of microphones (e.g., an array of six microphones). In some implementations, the playback device 100 includes more than six microphones (e.g., eight microphones or twelve microphones) or fewer than six microphones (e.g., four microphones, two microphones, or a single microphone).

In operation, the voice-processing components 116 are generally configured to detect and process sound received via the microphones 118, identify potential voice input in the detected sound, and extract detected-sound data to enable a Voice Assistant Service (VAS) to process voice input identified in the detected-sound data. The voice processing components 116 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In some implementations, one or more of the voice processing components 116 may be a subcomponent of the processor 102.

As further shown in FIG. 1A, the playback device 100 also includes power components 126. The power components 126 include at least an external power source interface 128, which may be coupled to a power source (not shown) via a power cable or the like that physically connects the playback device 100 to an electrical outlet or some other external power source. Other power components may include, for example, transformers, converters, and like components configured to format electrical power.

In some implementations, the power components 126 of the playback device 100 may additionally include an internal power source 130 (e.g., one or more batteries) configured to power the playback device 100 without a physical connection to an external power source. When equipped with the internal power source 130, the playback device 100 may operate independent of an external power source. In some such implementations, the external power source interface 128 may be configured to facilitate charging the internal power source 130. In some examples, the external power source interface receives power via utility or wall power, or perhaps an external battery configured to charge other devices. In certain examples, the external power source interface is configured to receive power from an energy harvesting device (not shown) configured to generate electricity from an energy source (e.g., solar, wind, heat). A playback device comprising an internal power source may be referred to herein as a “portable playback device.”

The playback device 100 further includes a user interface 108 that may facilitate user interactions independent of or in conjunction with user interactions facilitated by one or more controller/user devices. An example controller device may be, for example, a mobile telephone, a PC, a tablet computer, etc. Controller devices may have installed thereon an application configured to control one or more playback devices in a playback system. In various embodiments, the user interface 108 includes one or more physical buttons and/or supports graphical interfaces provided on touch sensitive screen(s) and/or surface(s), among other possibilities, for a user to directly provide input. The user interface 108 may further include one or more of lights (e.g., LEDs) and the speakers to provide visual and/or audio feedback to a user. Via the user interface 108 and/or a controller device, the user can control various operations of the playback device 100, such as instructing and controlling playback of audio content, and/or configuring the playback device 100.

As an illustrative example, FIG. 1B shows an example housing 230 of the playback device 100 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 118 to either an on state or an off state.

As further shown in FIG. 1B, the control area 232 is at least partially surrounded by apertures formed in the top portion 234 of the housing 230 through which the microphones 118 (not visible in FIG. 1B) receive the sound in the environment of the playback device 100. The microphones 118 may be arranged in various positions along and/or within the top portion 234 or other areas of the housing 230 so as to detect sound from one or more directions relative to the playback device 100.

By way of illustration, SONOS, Inc. presently offers (or has offered) for sale certain playback devices that may implement certain of the embodiments disclosed herein, including a “PLAY:1,” “PLAY:3,” “PLAY:5,” “PLAYBAR,” “CONNECT:AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIGS. 1A or 1B or to the SONOS product offerings. For example, a playback device may include, or otherwise take the form of, a wired or wireless headphone set, which may operate as a part of a playback system via a network interface or the like. In another example, a playback device may include or interact with a docking station for personal mobile media playback devices. In yet another example, a playback device may be integral to another device or component such as a television, a lighting fixture, or some other device for indoor or outdoor use.

It will be appreciated that one or more components illustrated in FIG. 1A are optional, and may be omitted from a playback device. In its simplest form, a playback device 100 comprises one or more processors 102, memory 104 storing instructions, and one or more drivers 114.

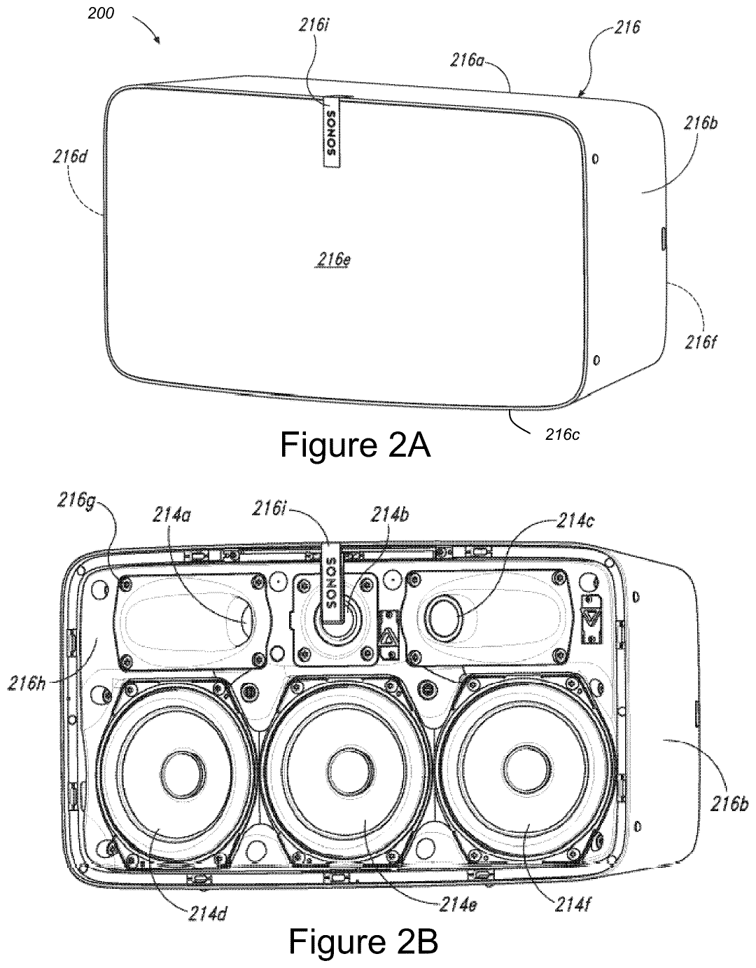

FIG. 2A is a front perspective view of a playback device 200 configured in accordance with examples of the disclosed technology. FIG. 2B is a front perspective view of the playback device 200 without a grille 216e. Referring to FIGS. 2A and 2B together, the playback device 200 comprises a housing 216 that includes a top surface 216a, a right or first side surface 216b, a bottom surface 216c, a left or second side surface 216d, the grille 216e, and a rear surface 216f. A plurality of fasteners 216g (e.g., one or more screws, rivets, clips) attaches a frame 216h to the housing 216. A cavity (not shown) in the housing 216 is configured to receive the frame 216h and electronics (not shown). The frame 216h is configured to carry a plurality of drivers 214 (identified individually in FIG. 2B as drivers 214a-f). The electronics are configured to receive audio content from an audio source and send electrical signals corresponding to the audio content to the drivers 214 for playback.

The drivers 214 are configured to receive the electrical signals from the electronics, and further configured to convert the received electrical signals into audible sound during playback. For instance, the drivers 214a-c (e.g., tweeters) can be configured to output high frequency sound (e.g., sound waves having a frequency greater than about 2 kHz). The drivers 214d-f (e.g., mid-woofers, woofers, midrange speakers) can be configured output sound at frequencies lower than the drivers 214a-c (e.g., sound waves having a frequency lower than about 2 kHz). In some examples, the playback device 200 includes a number of drivers different than those illustrated in FIGS. 2A-2C. For example, the playback device 200 can include fewer than six drivers (e.g., one, two, three). In other examples, however, the playback device 200 includes more than six drivers (e.g., nine, ten). Moreover, in some examples, all or a portion of the drivers 214 are configured to operate as a phased array to desirably adjust (e.g., narrow or widen) a radiation pattern of the drivers 214, thereby altering a user's perception of the sound emitted from the playback device 200.

In the illustrated example of FIGS. 2A and 2B, a filter 216i is axially aligned with the driver 214b. The filter 216i can be configured to desirably attenuate a predetermined range of frequencies that the driver 214b outputs to improve sound quality and a perceived sound stage output collectively by the drivers 214. In some examples, however, the playback device 200 omits the filter 216i. In other examples, the playback device 200 includes one or more additional filters aligned with the drivers 214b and/or at least another of the drivers 214.

### III. Playback Devices Having Adjustable Transducer Positions

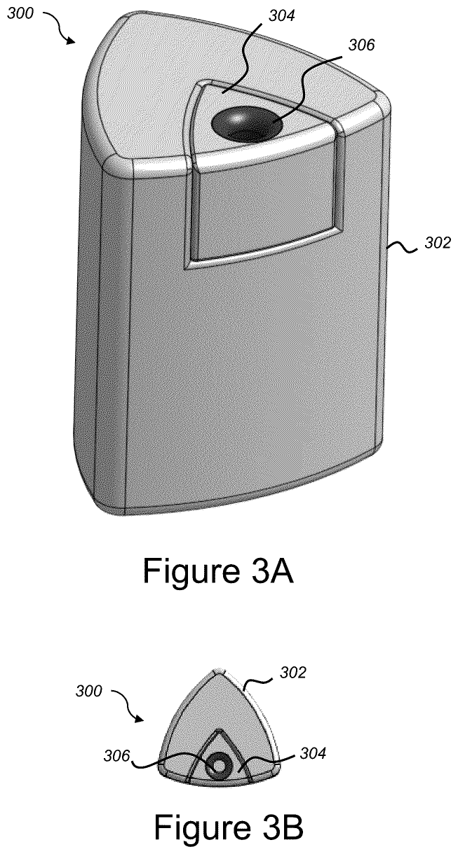

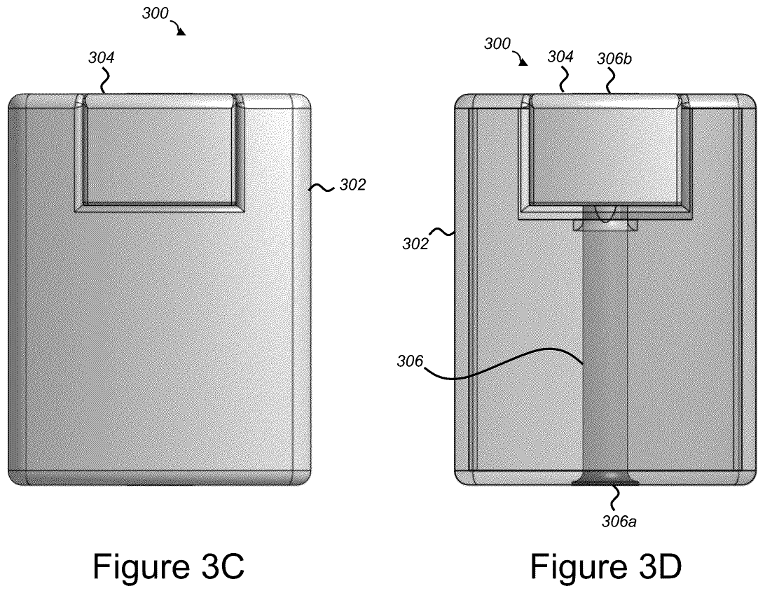

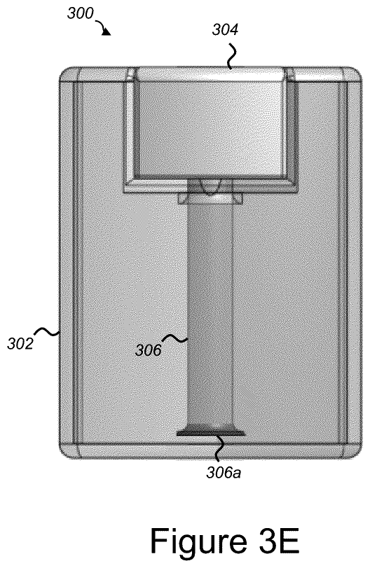

FIG. 3A is a perspective view of a playback device 300 according to example of the present invention. FIG. 3B is a top-down view of the playback device 300 of FIG. 3A, FIG. 3C is a side view of the playback device 300 of FIG. 3A, and FIG. 3D corresponds to the view of FIG. 3C, with partial transparency.

In contrast to playback devices 100 and 200 discussed above, the playback device 300 has two body portions which are moveable relative to each other. The playback device 300 may include any or all of the components described above in relation to FIGS. 1A, 1B, 2A and 2B but in the form factor of the playback device 300 depicted. For example, certain components may be housed in one of the body portions, while other components may be housed in the other body portion.

In particular, the playback device 300 comprises a first body portion 302 and a second body portion 304. In this example, the first body portion 302 may be alternatively referred to as a lower body portion 302 and the second body portion 304 may be alternatively referred to as an upper body portion. Although not visible in FIGS. 3A-3D, the playback device 300 further comprises at least a first speaker driver mounted in the first body portion 302 and a second speaker driver mounted in the second body portion 304. The first speaker driver outputs sound of a lower frequency than sound output by the second speaker driver. In this particular case, the first speaker driver is a woofer, and the second speaker driver is a tweeter. As discussed above, there may be one or more further drivers in either, or both, of the body portions 302, 304.

As is most clearly visible in FIG. 3D, the playback device 300 further comprises a substantially rigid connecting portion 306 extending between the first body portion 302 and the second body portion 304. As will become apparent, the connecting portion 306 is moveable and/or extendable to configure the playback device 300 in at least a first configuration and a second configuration. FIGS. 3A-3D depict the playback device 300 arranged in the first configuration. In the second configuration, the first and second body portions 302, 304 are arranged farther apart than in the first configuration. In the particular case shown in FIGS. 3A-3D, the first and second body portions 302, 304 are abutting each other; as such, the second body portion 304 is resting on top of the first body portion 302. In other examples, however, the first and second body portions 302, 304 may not be abutting in the first configuration.

As shown most clearly in FIGS. 3A and 3D, the connecting portion 306 is tubular and has a hollow interior. FIG. 3D shows the first body portion 302 as being partially transparent, so that the connecting portion 306 is visible within the first body portion 302. A first end 306a of the connecting portion is therefore located within the internal volume defined by the first body portion 302. As will be apparent from FIGS. 3A and 3B, the connecting portion 306 also extends into and, in this case fully through, the second body portion 304, such that a second end 306b of the connecting portion terminates at an outer surface of the second body portion 304. In this case, the second end 306b terminates at a top/upper surface of the second body portion 304.

In this particular example, the connecting portion 306 at least partially defines a bass port of the playback device 300. As discussed, a bass port is present to enhance low frequency audio output of the playback device 300. As such, the first body portion 302 may be known as a vented box, since the interior volume of the first body portion 302 is exposed to the air outside of the playback device 300 via the bass port. The connecting portion 306, and therefore the bass port, is moveable to allow the playback device 300 to be configured in the first and second configurations. In alternative examples, the connecting portion may be an extendable/telescopic or moveable rod (and may not necessarily have a hollow interior).

As will be discussed later, in FIG. 3E, a modified version of the playback device 300 is depicted, in which the connecting portion 306 does not extend as far into the first body portion 302.

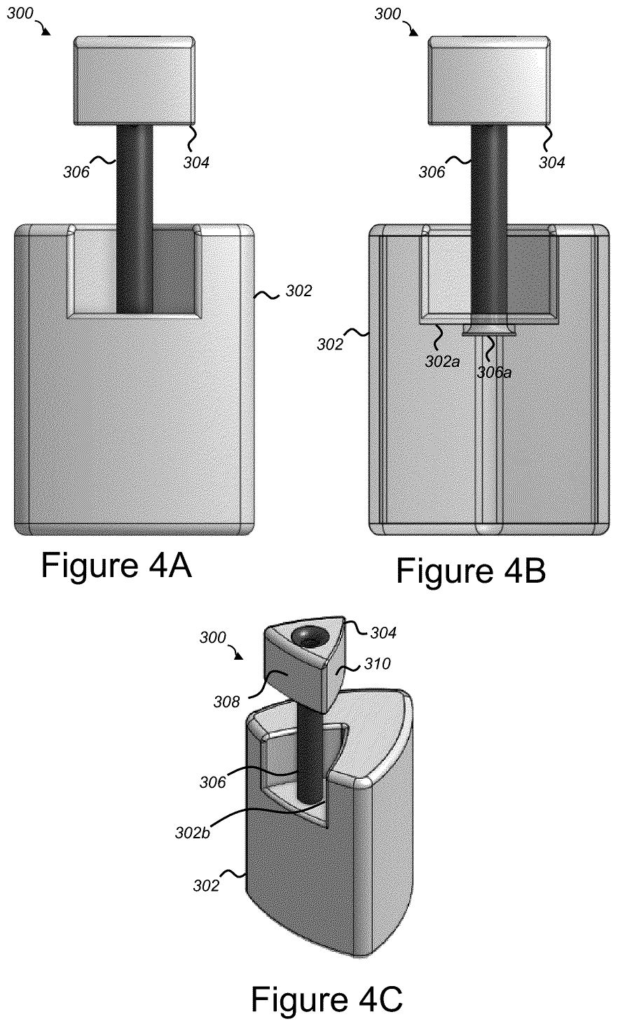

FIGS. 4A-4C depict the playback device 300 of FIGS. 3A-3D arranged in the second configuration, in which the first and second body portions 302, 304 are arranged farther apart than in the first configuration. Accordingly, the height of the second body portion 304 relative to the first body portion 302 can be adjusted as the playback device 300 is moved from the first configuration to the second configuration. Adjusting the height separation between the first and second body portions 302, 304 allows a greater height separation between the first and second speaker drivers. As discussed, where the second speaker driver (present in the second body portion 304) outputs audio of a higher frequency than the first speaker driver, the second speaker driver can therefore be arranged closer to the height of a listener's ears.

In certain cases, the second configuration may be said to be the configuration in which the first and second body portions 302, 304 are separated by the greatest distance achievable by the connecting portion 306. In some examples, the playback device 300 may be arranged in at least a third configuration, in which the first and second body portions 302, 304 are arranged farther apart from each other than in the first configuration, but closer together than in the second configuration.

To adjust the playback device 300 between the first and second configurations, a user/listener may manually move the first and second body portions 302, 304 away from each other (for example, by taking hold of the second body portion 304 and physically moving it away from the first body portion 302 (i.e., in an upwards direction)). In other cases, however, the playback device 300 itself may move the playback device 300 between the first and second configurations. In either case, the playback device 300 can detect which configuration it is currently arranged in, so that it can operate according to the current configuration.

As shown most clearly in FIG. 4B, as the playback device 300 moves from the first configuration to the second configuration, the connecting portion 306 moves relative to the first body portion 302. In particular, the connecting portion 306 is translated from the position shown in FIG. 3D, to the position shown in FIG. 4B. In this case, the connecting portion 306 remains in a fixed positional relationship with the second body portion 304. The movement of the connecting portion 306 may be said to be along a predetermined path/axis, and the second body portion 304 also moves along the same path/axis. As will be discussed, in some cases, the connecting portion 306 can additionally, or alternatively, be extended in length.

Due to the movement of the connecting portion 306 within the first body portion 302, in the first configuration (shown most clearly in FIG. 3D), the connecting portion 306 extends into the first body portion 302 by a first distance, and in the second configuration (shown most clearly in FIG. 4B), the connecting portion 306 extends into the first body portion 302 by a second distance, the second distance being less than the first distance. The extension distance into the first body portion 302 may be measured from a reference point on or within the first body portion 302, such as a distance measured from surface 302a in a direction along the predetermined path/axis.

In some cases, due to the difference of extension distance into the first body portion 302, the playback device's 300 sound profile may differ between configurations. To avoid this variance in output, the playback device 300 may be configured to adjust at least one audio output parameter based on whether the playback device is arranged in the first configuration or the second configuration to compensate. For example, as a result of the displacement of the connecting portion 306, the playback device 300 may adjust its equalisation setting to compensate.

As mentioned earlier, in some examples, one or more speaker drivers mounted in the second body portion 304 can be activated/deactivated when the playback device 300 moves between different configurations. For example, in one case, the playback device 300 additionally comprises a third speaker driver mounted in the second body portion 304. As shown in FIG. 4C, the second speaker driver mounted in the second body portion 304 may be arranged facing outwards from a first side 308 of the second body portion 304 and the third speaker driver mounted in the second body portion 304 may be arranged facing outwards from a second side 310 of the second body portion 304. As such, when the playback device 300 is arranged in the first configuration, any sound output by the third speaker driver would be directed towards a surface 302b of the first body portion (the third speaker driver may therefore terminate in gap or spacing between the first and second body portions 302, 304 when the playback device 300 is in the first configuration). Access to the third speaker driver in the first configuration may therefore be limited. The third speaker may therefore sound muffled or attenuated. It may therefore be beneficial to: (i) deactivate the third speaker driver (i.e., configure the third speaker driver to be in a deactivated state, in which the driver cannot output sound, despite the playback device 300 playing audio) when the playback device 302 is in the first configuration, and (ii) activate the third speaker driver (i.e., configure the third speaker driver to be in an active state, in which the driver can output sound) when the playback device 302 is in the second configuration. In contrast, the first and second speaker drivers may be in activated states regardless of the configuration.

As shown in FIG. 3D, in some cases, the connecting portion 306 has one or more ends which are at least partially sealed when the playback device 300 is arranged in the first configuration. This means that the connecting portion 306 cannot function, or cannot function properly, as a bass port. For example, in FIG. 3D, due to the length of the connecting portion 306 and the dimensions of the first body portion 302, the first end 306a of the connecting portion 306 is sealed by being flush with an inner surface of the first body portion 302 and the second end 306b is open (as shown in FIGS. 3A and 3B). When the playback device 300 is arranged in the second configuration, the first end 306a is no longer flush with the inner surface of the first body portion 302 (as shown in FIG. 4B), so the connecting portion 306 can correctly function as a bass port.

Although not present in the example playback device 300, in some cases, the second end 606b of the connecting portion 306 may alternatively or additionally be sealed when the playback device is arranged in the second configuration. For example, rather than having the second end 306b of the connecting portion 306 terminate at an upper surface of the second body portion 304, the connecting portion 306 may bend inside the second body portion 304 and terminate at the second side 310 of the second body portion 304. As such, when the playback device 300 is arranged in the first configuration, the second end 306b of the connecting portion 306 may terminate in gap or spacing between the first and second body portions 302, 304 when the playback device 300 is in the first configuration).

As briefly mentioned earlier, FIG. 3E depicts an alternative form of the playback device 300, in which the length of the connecting portion 306 and the dimensions of the first body portion 302 mean that the first end 306a of the connecting portion 306 is open when the playback device 300 is arranged in the first configuration and the second configuration. The connecting portion 306 may therefore function as a bass port in both the first and second configurations.

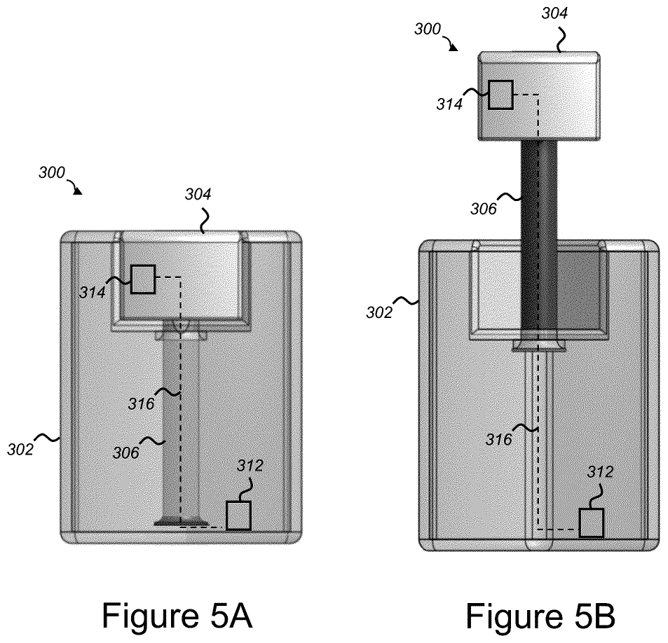

FIG. 5A depicts the playback device 300 in the first configuration, with partial transparency. FIG. 5B depicts the playback device 300 in the second configuration, with partial transparency. As shown, the playback device 300 comprises a first component 312 within the first body portion 302 that is electrically coupled to a second component 314 within the second body portion 304. Data and/or power can be transmitted between the first and second components 312, 314 via one or more wires 316 which pass through the hollow interior of the connecting portion 306. In this example, the first component 312 is a power component 312 (such as a power component 126 described in relation to FIG. 1A), and the second component 314 is a component requiring power, such as an amplifier or transducer. As such, power can be transferred from the power component 312 to the second component 314 via the connecting portion 306. When the playback device 300 moves between the first and second configurations, the one or more wires 316 may change positions and/or retract/extend due to the movement of the first and second body portions 302, 304.

In the examples of FIGS. 3A-5B, discussed above, the connecting portion 306 has a length equal to a length of the bass port. That is, the connecting portion 306 defines the entire bass port. In other examples, however, the bass port has a length that is less than a length of the connecting portion, depending upon the configuration of the playback device.

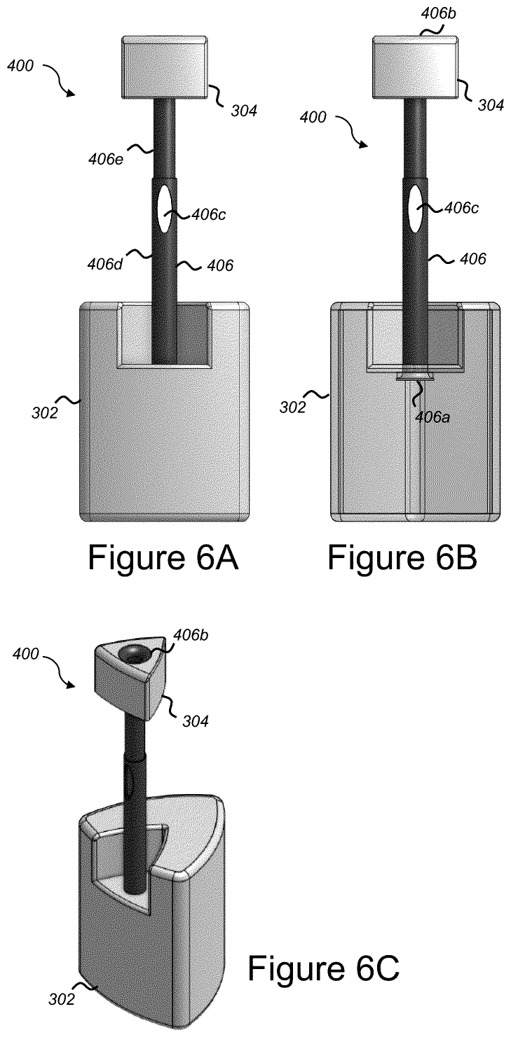

To illustrate, FIG. 6A depicts an example playback device 400 having the same features as the playback device 300 of FIGS. 3A-5B, but with a connecting portion 406 having an opening/aperture 406c at a position along its length, between a first end 406a and a second end 406b of the connecting portion 406. FIG. 6B is a side view of the playback device 400 of FIG. 6A, with partial transparency and FIG. 6C is a perspective view of the playback device 400. In FIGS. 6A-6C, the playback device 400 is arranged in the second configuration. For simplicity, features of the playback device 400 that correspond to those in the playback device 300 of FIGS. 3A-5B will be referred to as having the same reference numbers. That is, the playback device 400 also comprises a first portion 302 and a second portion 304.

In some cases, as shown in FIG. 6A, the aperture 406c extends fully through the connecting portion 406, through two sides of the connecting portion 406 to provide a through hole, but in other examples, the aperture 406c may only extend through one side of the connecting portion 406 so as not to provide a through hole.

The connecting portion 406 has a length, or true length, defined between the first and second ends 406a, 406b, and an effective length defined between the first end 406a and the aperture 406c (when the aperture 406c is open). The aperture 406c, when open, defines one end of the bass port, while the first end 406a of the connecting portion defines the other end of the bass port. As such, when the aperture 406c is open, the bass port has a length equal to an effective length of the connecting portion 406c, which is less than the true length of the connecting portion 406. When the aperture 406c is closed (or partially closed to the extent that it no longer allows the aperture 406c to act as one end of the bass port), the bass port has a length defined between the first and second ends 406a, 406b of the connecting portion 406. In such cases, when the aperture 406c is closed (or partially closed), the effective length of the connecting portion 406 is equal to the true length of the connecting portion 406.

In the example playback device 400, the connecting portion 406 is adjustable in length, between at least a first length and a second length, the second length being longer than the first length, the first and second lengths being measured between a first end 406a of the connecting portion 406 and a second end 406b of the connecting portion 406. The connecting portion 406 may therefore be telescopic or extendable/retractable. To achieve this extendable/telescopic nature, the connecting portion 406 comprises two or more parts, which can move/slide/translate relative to each other. For example, FIG. 6A shows a first part 406d and a second part 406e. The second part 406e has a cross-sectional width that is smaller than the cross-sectional width of the first part 406d so that it can slide and therefore nest within the first part 406d as the playback device 400 is moved from the second configuration to the first configuration.

As such, in one example, playback device 400 can be adjusted to be in the second configuration shown in FIGS. 6A-6C, and a first configuration like that shown in FIGS. 3A-3E. When the playback device 400 is in the first configuration, the connecting portion 406 has the first, shorter length, and when the playback device is in the second configuration, the connecting portion has the second, longer length.

The presence of the open aperture 406c allows the bass port to have a constant length regardless of the length of the connecting portion 406 (i.e., regardless of whether the playback device 400 is arranged in the first or second configuration). In such a case, when the connecting portion 406 has the first length: (i) the aperture 406c is closed, and (ii) the bass port has a length substantially equal to the first length. When the connecting portion 406 has the second length, as shown in FIGS. 6A-6C: (iii) the aperture 406c is open, and (iv) the bass port has a length substantially equal to the first length, the length of the bass port being measured between the first end 406a of the connecting portion 406 and the open aperture 406c.

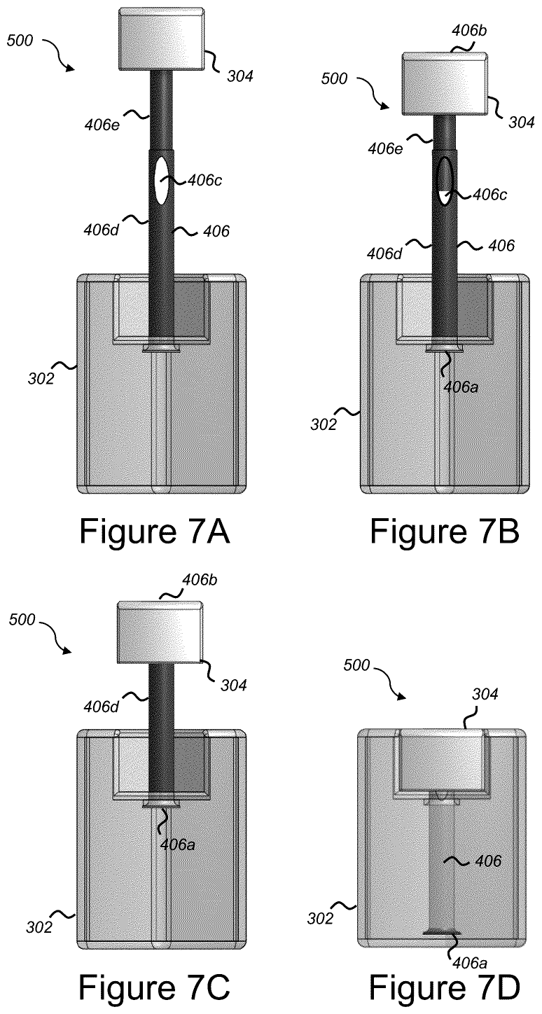

As mentioned, in some cases, a playback device can be arranged in at least three configurations. To illustrate, FIG. 7A depicts an example playback device 500 having the same features as the playback device 400 of FIGS. 6A-6C, but the playback device 500 can additionally be arranged in at least a third configuration that is between the first and second configurations. As with the example playback device 400 of FIGS. 6A-6C, the playback device 500 has a connecting portion 406 having an opening/aperture 406c along its length. FIG. 7A depicts the playback device 500 in the second configuration, that is, in a configuration in which the connecting portion 406 has its greatest length, and the first and second body portions 302, 304 are separated by their greatest distance.

FIG. 7B is a side view of the playback device 500 where the height separation between the first and second body parts 302, 304 is less than that shown in FIG. 7A. As shown, the second part 406e of the connecting portion 406 is partially nesting within the first part 406d, so the ends 406a, 406b of the connecting portion 406 are closer together (meaning the length of the connecting portion 406 is less than that shown in FIG. 7A due to this retraction). FIG. 7B shows the aperture 406c as partially closed by the second part 406e of the connecting portion 406. The first part 406d of the connecting portion 406 is in the same position as that shown in FIG. 7A, so extends into the first body portion 302 by the same distance as in FIG. 7A.

As the second body portion 304 continues to move closer to the first body portion 302, the length of the connecting portion 406 continues to decrease until the aperture 406c is fully closed and the second part 406e is fully nested within the first part 406d of the connecting portion 406. At this point, the connecting portion 406 is unable to retract any further (so has a minimum length) and defines the full length of the bass port. This arrangement is depicted in FIG. 7C. This arrangement may be referred to as being a third configuration of the playback device 500, where the first and second body portions 302, 304 are arranged farther apart than in the first configuration (shown in FIG. 7D), and closer together than in the second configuration (shown in FIG. 7A). FIG. 7B therefore shows the playback device 500 between the second and third configurations (which may itself be referred to as a fourth, or further, configuration).

To arrange the playback device 500 in the first configuration, from the third configuration of FIG. 7C, the second body portion 304 continues to move closer to the first body portion 302. Given that the length of the connecting portion 406 is at its minimum, the connecting portion 406 therefore moves/translates relative to the first body portion 302, rather than retracting in length. As such, when the playback device 500 is arranged in the first configuration shown in FIG. 7D, the connecting portion 406 has a length equal to the length of the bass port, which is the same length as in the third configuration.

Accordingly, as shown in FIGS. 7A-7D, the connecting portion 406 is adjustable in length, between at least a first length and a second length, the second length being longer than the first length. As such, when the playback device 500 is arranged in both the first configuration (shown in FIG. 7D) and the third configuration (shown in FIG. 7C) the connecting portion 406 has the first, minimum, length, and the aperture 406c is fully closed. The bass port therefore has a length substantially equal to the first length. When the playback device 500 is arranged in the second configuration (shown in FIG. 7A), the connecting portion 406 has the second, maximum, length, and the aperture 406c is open. The bass port therefore has a length equal to the effective length of the connecting portion 406 (measured between the first end 406a and the aperture 406c). Due to the aperture 406c being open, and its precise position along the length of the connecting portion 406, the bass port also has a length substantially equal to the first length when the playback device 500 is in the second configuration. As such, regardless of the configuration, the bass port length may be kept constant, resulting in a more balanced operation of the playback device 500.

In some cases, the playback device 500 may operate when the bass port has a length that is different to the first length. For example, in FIG. 7B, the aperture 406c may be said to be effectively closed, so that the bass port does not terminate at the partially open aperture 406c, and instead has a length measured between the first and second ends 406a, 406b of the connecting portion. In other cases, the aperture 406c may be fully closed before the height difference between the first and second body portions 302, 304 corresponds to that shown in FIG. 7C. Further still, in some cases, the connecting portion may be extendable, but may not have an aperture along its length, so the bass port has a variable length. In each case, the playback device's 500 sound profile may differ (compared to when the bass port has a constant length) depending on the length of the bass port. To avoid this variance in output, the playback device may be configured to adjust at least one audio output parameter based on the length of the connecting portion (and/or bass port) to compensate.

As discussed, in some examples, the playback devices 300, 400, 500 are configured to adjust between the first, second (and in some cases third) configurations based on one or more of: a characteristic of the audio being, or to be, played back by the playback device, a location of the playback device, an audio output parameter of the playback device, an operation mode of the playback device or a command, the command being based on user input to the playback device (such as via the user interface 108) or a user device (such as a controller device) in communication with the playback device (such as via the network interface 120).

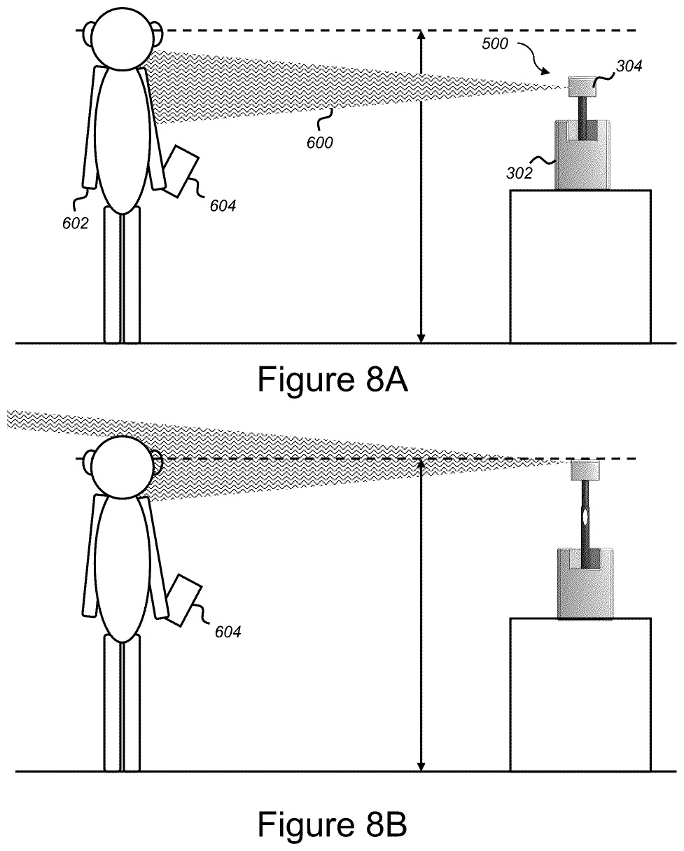

In one particular example, the playback device 300, 400, 500 is configured to move from the first configuration to the second (or further) configuration based on the location of the playback device relative to a listener, so as to position the second body portion 304 as close as possible to the height of the listener's head/cars. To illustrate, FIG. 8A depicts a playback device 500 comprising a signal transmitter and receiver/detector, such as an infrared transmitter and receiver/detector, capable of determining the height of a listener 602. In some examples, the signal comprises a sound signal (e.g., an audible sound signal, an ultrasound signal, a sound signal having a frequency between about 18 kHz to 20 kHz) and/or an electromagnetic signal (e.g., an infrared signal, an ultra-wideband signal, a light signal such as a laser pulse, a WiFi signal, a Bluetooth signal, a radio frequency signal, and/or another electromagnetic signal). For example, U.S. Pat. No. 10,277,981 filed on Oct. 2, 2018, and titled “Systems and Methods of User Localization,” which is hereby incorporated by reference in its entirety, provides in more detail some examples for playback devices determining the location(s) of one or more listeners using sound signals. In FIG. 8A, the listener 602 is in a standing position, and prior to this, the listener 602 may have been seated, so the second body portion 304 of the playback device 500 was already located approximately at head height. The change in head height of the listener 602 may therefore cause the playback device 500 to change its configuration.

In the example of FIG. 8A, the playback device 500 is outputting a signal 600 which is reflected from a listener 602 and detected by the receiver/detector. The playback device 500, upon receiving the reflected signal, can process this to determine whether the second body portion 304 is at, or is close to, head height. In this case, the strength and/or signature of the reflected signal indicates that the second body portion 304 is not yet at head height, so the playback device 500 continues to increase the separation/height distance between the first and second body portions 302, 304.

Although FIG. 8A shows the playback device 500 arranged in the third configuration (or at some position between the first and second configurations), it will be appreciated that the same process may be performed when the playback device 500 is in the first configuration (depending upon the location of the electromagnetic transmitter and receiver).

FIG. 8B show the playback device 500 at a later time, when the playback device 500 is arranged in the second configuration. In this case, the strength and/or signature of the reflected signal indicates that the second body portion 304 is at head height, so the playback device 500 remains in this configuration. Should the listener 602 sit down again, the playback device 500 may determine that the strength and/or signature of the reflected signal indicates the listener 602 has moved again, so determines to move to another configuration, such as the third or first configuration. Accordingly, the height of the second body portion 304 relative to the first body portion 302 is based a location of the playback device 500 relative to a listener.

It will be appreciated that other systems for detecting the location of a listener can be used, such as a lidar system and/or camera system and/or one or more microphones.

Additionally, or alternatively, a listener/user may instruct/command the playback device 500 to move to a certain, or different, configuration. For example, the listener/user 602 may provide user input to a user/controller device 604 or the playback device itself 500 to instruct the playback device 500 to move to a particular configuration. In one example, the listener may provide a voice input to the user device 604 and/or the microphones of the playback device 500 to instruct the playback device to move to a particular configuration. As a result of the user input, a command may be generated to cause the playback device 500 change configuration.

Although FIGS. 8A and 8B show playback device 500, it will be appreciated that the same principles can be applied to any of the other playback devices described above or below (such as a device capable of only being arranged in two configurations, rather than three).

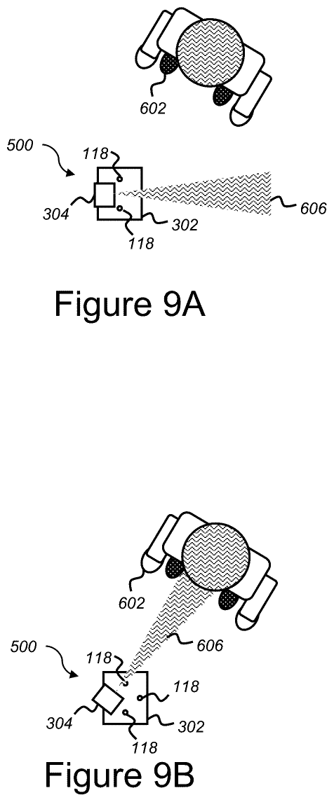

In some cases, the second body portion 304 may be configured to rotate and/or tilt relative to the first body portion 302 while the playback device is in the second configuration (and or the third or further configurations). To illustrate, FIG. 9A depicts a top-down view of a playback environment comprising a playback device 500 and a listener/user 602, where the playback device 500 has a plurality of microphones 118, in this case three microphones 118.

In some examples, the playback device is configured to cause the second body portion to rotate and/or tilt relative to the first body portion based on a location of a listener. In one case, to determine the location of the listener 602 relative to the playback device 500, the listener 602 speaks and/or a user device that is held by or is near to a user outputs a sound. The voice or sound is then detected by the plurality of microphones 118 and once the received sound has been received and processed, the direction/location of the listener 602 can be determined. Based on this determined location, the second body portion 304 may be automatically rotated such that sound 606 emitted from the second speaker driver in the second body portion 304 is directed towards the listener 602. FIG. 9A shows the playback environment of FIG. 9A once the second body portion 304 has been rotated towards the direction of the listener 602.

In some cases, the microphones 118 and/or any other location detection system (such as an electromagnetic transmitter/receiver) can be additionally or alternatively used to determine the height of a user, so that the second body portion 304 can be tilted to direct the sound 606 towards the head/ears of the listener 602.

It will be appreciated that other systems for detecting the location of a listener can be used, such as a lidar system and/or camera system and/or an electromagnetic transmitter/detector.

Additionally, or alternatively, a listener/user may instruct/command the playback device 500 to tilt and/or rotate. For example, the listener/user 602 may provide user input to a user/controller device or the playback device itself 500 to instruct the playback device 500 to tilt and/or rotate.

Although FIGS. 9A and 9B show playback device 500, it will be appreciated that the same principles can be applied to any of the other playback devices described above or below.

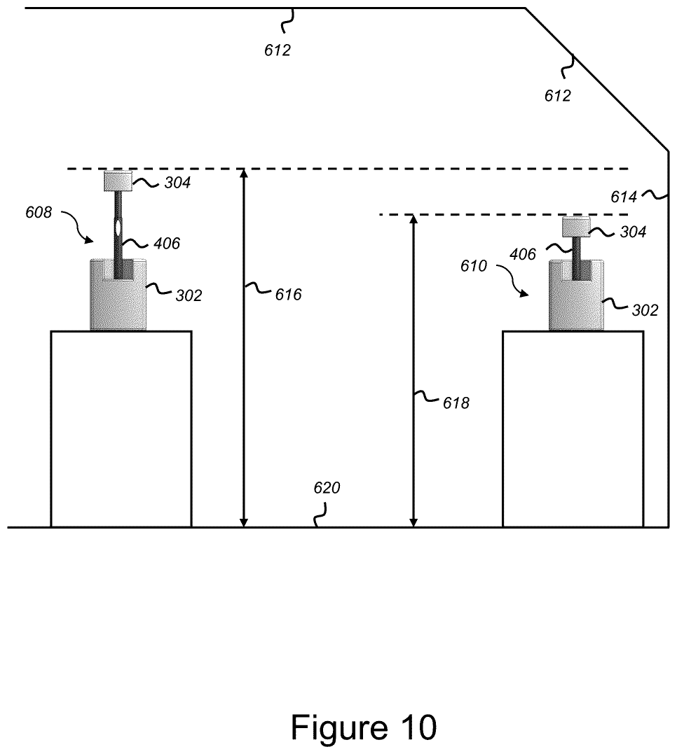

FIG. 10 depicts a system, such as all or part of a media playback system, comprising two playback devices, including a first playback device 608 and a second playback device 610. The playback devices 608, 610 may correspond to any of the playback devices described above or below (and in some cases may be different to each other), but in this example, both of the playback devices 608, 610 correspond to playback device 500.

The first playback device 608 comprises a first body portion 302 and a second body portion 304 (referred to herein as a first lower body portion 302 and a first upper body portion 304). A first speaker driver is mounted in the first lower body portion 302, and a second speaker driver mounted in the first upper body portion 304. The first playback device 608 further comprises a connecting portion 406 extending between the first upper body portion 304 and the first lower body portion 302. Similarly, the second playback device 610 comprises a first body portion 302 and a second body portion 304 (referred to herein as a second lower body portion 302 and a second upper body portion 304). A first speaker driver is mounted in the second lower body portion 302, and a second speaker driver is mounted in the second upper body portion 304. The second playback device 608 further comprises a connecting portion 406 (referred to as a second connecting portion 406) extending between the second upper body portion 304 and the second lower body portion 302.

In some cases, the media playback system can comprise one or more playback zones, some of which may correspond to rooms or areas in a building, such as a home, office, hotel etc. and/or outdoor space, such as a garden, patio, or balcony. Each zone may be given a name according to a different room or area such as the office, master bathroom, master bedroom, second bedroom, kitchen, dining room, living room, garden and/or the balcony. In some examples, a single playback zone may include multiple rooms or spaces. In certain examples, a single room or space may include multiple playback zones. Each zone within the playback system may comprise one or more playback devices. In cases where a zone comprises a plurality of playback devices, the playback devices may form a group, where the playback devices within the group play back the same media in synchrony.

In this particular case, the first and second playback devices 608, 610 form at least part of a group configured to output audio in synchrony. As such, their actions may be coordinated to optimize sound output in the playback environment (such as the room or area) in which they are located.

FIG. 10, for example depicts a room where the particular room geometry is different near to each playback device 608, 610. For example, the distances to the ceiling 612 and wall 614 are different for each playback device 608, 610. Due to this difference in geometry, it may not always be beneficial to have both playback devices 608, 610 in the same configuration (that is, to have both the upper body portions 304 of each playback device 608, 610 to be at the same height).

Accordingly, in some example systems, based on the location of the first playback device 608 within the playback environment, the first playback device 608 is configured such that the first upper body portion 304 is arranged at a first height 616 within the playback environment. Furthermore, based on the location of the second playback device 610 within the playback environment, the second playback device 610 is configured such that the second upper body portion 304 is arranged at a second height 618 within the playback environment, the second height 618 being different to the first height 616. As such, in the example of FIG. 10, the first playback device 608 is arranged in the second configuration, and the second playback device 610 is arranged in the third configuration. More generally, the two playback devices 608, 610 may be arranged in different configurations. As shown, the first and second heights 616, 618 are measured relative to the floor 620.

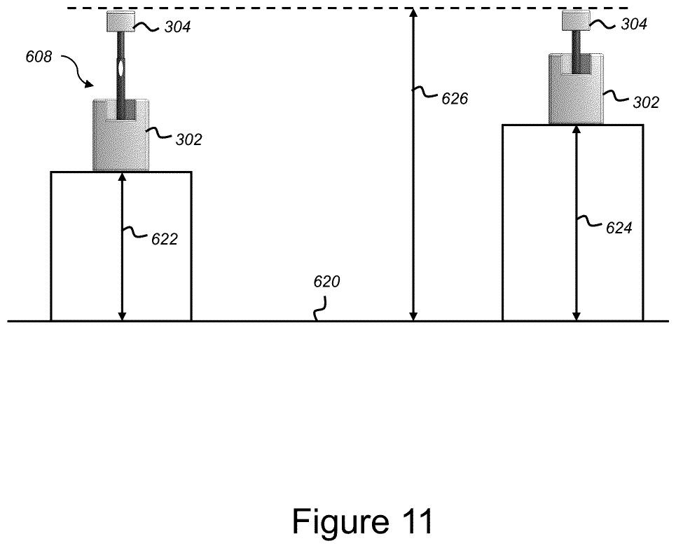

FIG. 11 depicts a system, such as all or part of a media playback system, comprising two playback devices, including a first playback device 608 and a second playback device 610. The playback devices 608, 610 may correspond to the playback devices described in reference to FIG. 10, so their features and components will not be described again, for brevity.

In addition to (or instead of) the functionality discussed in reference to FIG. 10, the playback devices 608, 610 may be configured such that when they are arranged at different heights within a playback environment, the upper body portions 304 of the first and second playback devices 608, 610 are at substantially the same height in the playback environment.

Accordingly, in FIG. 11, the first and second playback devices 608, 610 are arranged such that the lower body portions 302 are at different heights within the playback environment. For example, the first lower body portion 302 of the first playback device 608 is arranged at a first height 622, and the second lower body portion 302 of the second playback device 610 is arranged at a second height 624. Despite this offset in heights, the upper body portions 304 of the first and second playback devices 608, 610 are arranged at the same, third, height 626.

In some cases, the height 626 of the upper body portions 304 of the first and second playback devices 608, 610 is based on a location of a listener. For example, one or both playback devices may determine the location (such as the height) of a listener, as described earlier. In some cases, the height 626 of the upper body portions 304 of the first and second playback devices 608, 610 is additionally or alternatively based on the room geometry.

In the examples described above, the playback devices 300, 400, 500 each have a second body portion 304 that moves in a generally vertical direction towards and away from the first body portion 302. As mentioned, in alternative examples, rather than having the second body portion positioned above the first body portion, the two body portions may be separable in horizontal distance.

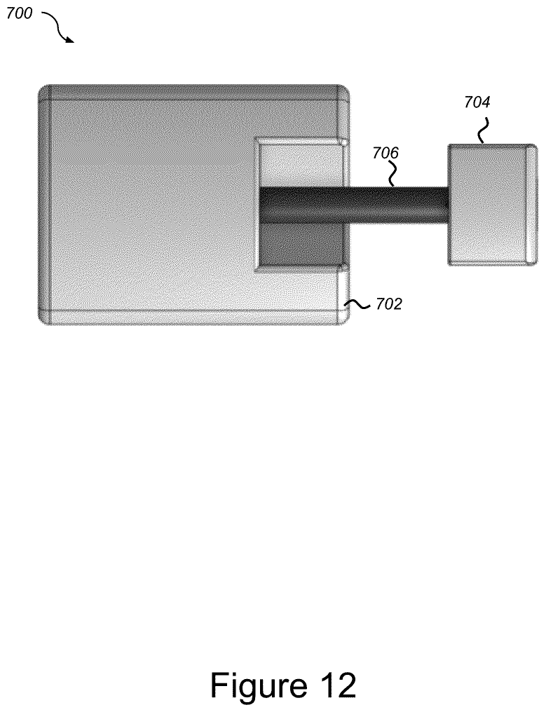

To illustrate, FIG. 12 depicts a playback device 700, where the playback device has a first body portion 702, a second body portion 704, and a connecting portion 706. The first body portion 702 houses a first speaker driver and the second body portion 704 houses a second speaker driver. The connecting portion 706 is moveable or extendable to adjust the horizontal separation between the first body portion 702 and the second body portion 704. The second body portion 704 may be referred to as a side portion. As such, the side portion 704 can be moved relative to the first body portion 702.

Although oriented differently, the playback device 700 comprises any or all of the components described above. For example, the connecting portion 706 may at least partially define a bass port of the playback device 700.

In one particular case, the first speaker driver is configured to output a left channel of audio, and the second speaker driver is configured to output a right channel of audio (or vice versa). Accordingly, when the playback device 700 is arranged in the second configuration (shown in FIG. 12), a greater stereo separation may be achieved.

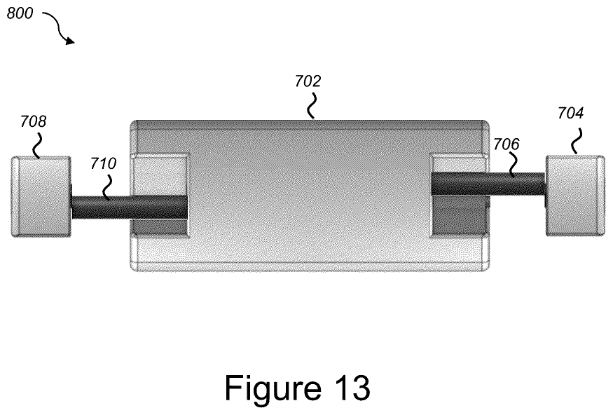

In a further example, as shown in FIG. 13, a playback device 800 comprises the first and second body portions 702, 704 of playback device 700, and a connecting portion 706 extending between them. The playback device 800 further comprises a third body portion 708 located on an opposite side of the first body portion 702 to the second body portion 704, a third speaker driver mounted in the third body portion 708, and a second connecting portion 710 extending between the first body portion 702 and the third body portion 706.

The second connecting portion 710 is moveable or extendable to configure the playback device 800 in at least the first configuration (in which the second and third body portions 704, 708 are at their closest distance to the first body portion 702) and a third configuration (in which the first and third body portions 702, 708 are arranged farther apart than in the first configuration and the first and second body portions 702, 710 are arranged farther apart than in the first configuration). FIG. 13 therefore shows the playback device 800 in the third configuration.

When the playback device is arranged in the second configuration, the first and second body portions 702, 704 are arranged farther apart than in the first configuration, and the first and third body portions 702, 704 are at their closest distance (as they were in the first configuration). As will be apparent, further configurations may also be possible.

In some cases, as is shown in FIG. 13, the connecting portions 706, 710 may be offset so that they do not come into contact when the playback device 800 is in the first configuration.

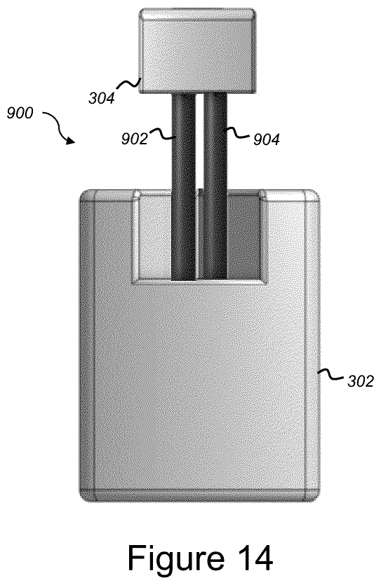

In the examples described above, the playback devices 300, 400, 500, 608, 610, 700, 800 each have a single connecting portion extending between the first and second body portions. In other examples, however, the playback devices 300, 400, 500, 608, 610, 700, 800 may further comprise a second connecting portion extending between the first body portion and the second body portion, where the second connecting portion is also moveable or extendable to configure the playback device in at least the first configuration and the second configuration. As such, FIG. 14 depicts an example playback device 900 having a first connecting portion 902 and a second connecting portion 904 extending between the first and second body portions 302, 304. The additional connecting portion can provide extra stability.

References herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

1. A playback device, comprising:
a first body portion;
a second body portion;
a first speaker driver mounted in the first body portion;
a second speaker driver mounted in the second body portion; and
a substantially rigid connecting portion extending between the first body portion and the second body portion, wherein the connecting portion is moveable and/or extendable to configure the playback device in at least a first configuration and a second configuration, wherein in the second configuration the first and second body portions are arranged farther apart than in the first configuration.

2. The playback device of claim 1, wherein:
the first body portion is a lower portion of the playback device and the second body portion is an upper body portion of the playback device; and
the connecting portion is moveable or extendable to adjust the height of the upper body portion relative to the lower body portion.

3. The playback device of claim 2, wherein:
the second speaker driver mounted in the upper body portion is configured to output higher frequency audio than the first speaker driver mounted in the lower body portion.

4. The playback device of claim 3, further comprising:
a third speaker driver mounted in the upper body portion, wherein the third speaker driver is configured to output higher frequency audio than the first speaker driver mounted in the lower body portion.

5. The playback device of claim 4, wherein:
in the first configuration:
the second speaker driver is in an active state, such that the second speaker driver outputs audio; and
the third speaker driver is in a deactivated state, such that the third speaker driver does not output audio; and
in the second configuration:
the second speaker driver is in an active state, such that the second speaker driver outputs audio; and
the third speaker driver is in an active state, such that the third speaker driver outputs audio.

6. The playback device of claim 1, wherein:
the second body portion is a side portion of the playback device; and
the connecting portion is moveable or extendable to adjust the horizontal separation between the first body portion and the side portion of the playback device.

7. The playback device of claim 1, wherein the substantially rigid connecting portion at least partially defines a bass port of the playback device.

8. The playback device of claim 7, wherein:
the connecting portion is adjustable in length, between at least a first length and a second length, the second length being longer than the first length, the length being measured between a first end of the connecting portion and a second end of the connecting portion;
the connecting portion delimits an aperture along the length of the connecting portion between the first end and the second end; and
when the connecting portion has the first length:
the aperture is closed; and
the bass port has a length substantially equal to the first length, and
when the connecting portion has the second length:
the aperture is open; and
the bass port has a length substantially equal to the first length, the length of the bass port being measured between the first end of the connecting portion and the open aperture.

9. The playback device of claim 7, wherein:
in the first configuration, the connecting portion extends into the first body portion by a first distance;
in the second configuration, the connecting portion extends into the first body portion by a second distance, the second distance being less than the first distance; and
the playback device is configured to adjust at least one audio output parameter of the playback device based on whether the playback device is arranged in the first configuration or the second configuration.

10. The playback device of claim 7, wherein:
the connecting portion is adjustable in length, between at least a first length and a second length, the second length being longer than the first length, the length being measured between a first end of the connecting portion and a second end of the connecting portion; and
the playback device is configured to adjust at least one audio output parameter based on whether the connecting portion has the first length or the second length.

11. The playback device of claim 7, wherein:
the connecting portion has a first end and a second end; and
in the first configuration at least one of the first and second ends are sealed; and
in the second configuration the first and second ends of the connecting portion are open.

12. The playback device of claim 7, wherein one or more wires configured to carry data and/or power extend between the first and second body portions via the connecting portion.

13. The playback device of claim 7, further comprising:
a second substantially rigid connecting portion extending between the first body portion and the second body portion, wherein the second connecting portion is moveable or extendable to configure the playback device in at least the first configuration and the second configuration.

14. The playback device of claim 1, wherein the playback device is configured to detect that the playback device is in at least one of:
the first configuration; and
the second configuration.

15. The playback device of claim 1, wherein the second body portion is configured to rotate and/or tilt relative to the first body portion while the playback device is in at least the second configuration.

16. The playback device of claim 15, wherein the playback device is configured to cause the second body portion to rotate and/or tilt relative to the first body portion based on a location of a listener.

17. The playback device of claim 1, wherein the playback device is configured to adjust the playback device between the first and second configurations based on one or more of:
a characteristic of the audio being, or to be, played back by the playback device;
a location of the playback device;
an audio output parameter of the playback device;
an operation mode of the playback device; and
a command, the command being based on user input to the playback device or a user device in communication with the playback device.

18. A system, comprising:
a first playback device, having:
a first lower body portion;
a first upper body portion;
a first speaker driver mounted in the first lower body portion;
a second speaker driver mounted in the first upper body portion; and
a substantially rigid connecting portion extending between the first upper body portion and the first lower body portion, wherein the connecting portion is moveable and/or extendable to configure the first playback device in at least a first configuration and a second configuration, wherein in the second configuration the first upper body portion and the first lower body portion are arranged farther apart than in the first configuration; and
a second playback device, having:
a second lower body portion;
a second upper body portion;
a third speaker driver mounted in the second lower body portion;
a fourth speaker driver mounted in the second upper body portion; and
a second substantially rigid connecting portion extending between the second upper body portion and the second lower body portion, wherein the second connecting portion is moveable and/or extendable to configure the second playback device in at least a first configuration and a second configuration, wherein in the second configuration the second upper body portion and the second lower body portion are arranged farther apart than in the first configuration; and
wherein the first and second playback devices form at least part of a group configured to output audio in synchrony, and wherein:
based on a location of the first playback device within the playback environment, the first playback device is configured such that the first upper body portion of the first playback device is arranged at a first height within the playback environment; and
based on a location of the second playback device within the playback environment, the second playback device is configured such that the second upper body portion is arranged at a second height within the playback environment, the second height being different to the first height.

19. A system, comprising:
a first playback device, having:
a first lower body portion;
a first upper body portion;
a first speaker driver mounted in the first lower body portion;
a second speaker driver mounted in the first upper body portion; and
a substantially rigid connecting portion extending between the first upper body portion and the first lower body portion, wherein the connecting portion is moveable and/or extendable to configure the first playback device in at least a first configuration and a second configuration, wherein in the second configuration the first upper body portion and the first lower body portion are arranged farther apart than in the first configuration; and
a second playback device, having:
a second lower body portion;
a second upper body portion;
a third speaker driver mounted in the second lower body portion;
a fourth speaker driver mounted in the second upper body portion; and
a second substantially rigid connecting portion extending between the second upper body portion and the second lower body portion, wherein the second connecting portion is moveable and/or extendable to configure the second playback device in at least a first configuration and a second configuration, wherein in the second configuration the second upper body portion and the second lower body portion are arranged farther apart than in the first configuration; and
wherein:
the first and second playback devices form at least part of a group configured to output audio in synchrony; and
when the first and second playback devices are arranged at different heights within a playback environment:
the first and second playback devices are configured such that the upper body portions of the first and second playback devices are at substantially the same height in the playback environment.

20. The system of claim 19, wherein the height of the upper body portions of the first and second playback devices is based on a location of a listener.
